(19) United States
(12) Patent Application Publication
(10) Pub. No.: US 2004/0231141 A1
(43) Pub. Date: Nov. 25, 2004

(54) Laminate and its producing method

(76) Inventors: Masaru Nishinaka, Shiga (JP); Kanji Shimo-Ohsako, Osaka (JP); Takashi Itoh, Shiga (JP); Mutsuaki Murakami, Osaka (JP)

Correspondence Address: HOGAN & HARTSON L.L.P., 500 S. GRAND AVENUE, SUITE 1900, LOS ANGELES, CA, 90071-2611, US

(21) Appl. No.: 10/482,855

(22) PCT Filed: Jul. 4, 2002
(86) PCT No.: PCT/JP02/06777

(30) Foreign Application Priority Data
Jul. 6, 2001 (JP) 2001-206862
Aug. 3, 2001 (JP) 2001-237058
Nov. 14, 2001 (JP) 2001-348300
Nov. 14, 2001 (JP) 2001-348301
Nov. 14, 2001 (JP) 2001-348288

(51) Int. Cl. H01F 3/04; H01F 7/06

(52) U.S. Cl. 29/609; 29/830; 29/846

(57) ABSTRACT

A laminate is prepared by forming metal layer A on one face of a polymer film by dry plating method. When circuit is formed by using the laminate according to the semi-additive method, a high-density printed wiring board having excellent circuit shape, insulating property between the circuits and adhesion with the substrate can be obtained. By forming an adhesive layer on the other side of the polymer film of the laminate, an interlayer adhesive film is prepared. By thermally fusing or curing the adhesive layer after laminating the interlayer adhesive film on the inner layer circuit board, a multi-layer printed wiring board can be prepared. When preparing the circuit board by etching the first metal coating, an etchant which selectively etches the first metal coating is preferably used.

### TECHNICAL FIELD

The present invention relates to a laminate used widely in electric and electronic devices, comprising a metal layer of copper on a polymer film having a smooth plane and a process for preparing the same, particularly a laminate most suitable for preparing a circuit substrate and a process for preparing the same. More specifically, the present invention relates to a high-density printed wiring board prepared by semi-additive process and a process for preparing the same.

Furthermore, the present invention relates to a laminate for a build-up multi-layer printed wiring board, to which the semi-additive process is applicable, a build-up multi-layer printed wiring board which is prepared by using the laminate and applying the process and a process for preparing the same. More specifically, the present invention relates to an interlayer adhesive film for a multi-layer printed wiring board in which an insulating resin layer and a metal layer having a circuit pattern are laminated in sequence onto the metal layer of a wiring board (inner layer circuit board) having a circuit pattern, a build-up multi-layer printed wiring board obtained by using the film and a process for preparing the same.

### BACKGROUND ART

Printed wiring boards having a circuit on the surface of the insulating substrate are widely used in order to mount electronic parts and semiconductor devices. With the recent demand of miniaturization and high functions in electronic equipment, high-density circuits and thinning are strongly desired in printed wiring boards. Particularly, the establishment of a method of forming microcircuit in which the line/space interval is at most 25 μm/25 μm is an important problem in the printed wiring board field.

A method called the semi-additive process is being considered as a method for preparing such a high-density printed wiring board and as an example, the printed wiring board is prepared in the following steps.

After the surface of the insulating substrate is made rough and a plating catalyst such as a palladium compound is applied, electroless copper plating is conducted with the plating catalyst as the nucleus and a thin metal coating is formed on the surface of the polymer film.

Subsequently, a resist coating is applied or laminated to the surface of the electroless plating copper coating and certain portions of the resist where the circuit is to be formed are removed by methods such as photolithography. Electroplating of copper is then conducted with the area in which the electroless plating copper coating is exposed as the feeding electrode and a second metal coating is formed on the area where the circuit is to be formed.

After the resist coating is removed, any exposed unnecessary electroless plating copper coating is removed by etching. At this time, the surface of the electroplated copper coating is slightly etched as well and the thickness and width of the circuit pattern decreases.

Furthermore, nickel plating or gold plating is conducted to the surface of the formed circuit pattern according to need to prepare the printed wiring board.

In the semi-additive process, because the circuit is prepared by etching the thin electroless plating copper coating (first metal coating), a microcircuit can be accurately formed, compared to the method called the subtractive method in which a circuit is formed by etching thick metallic foil.

However, the semi-additive process is known to have the following problems.

The first problem is the problem of adhesion between the formed circuit pattern and the substrate. As mentioned before, the space between the substrate and the circuit pattern is in electroless plating copper layer. The electroless plating copper layer is formed in the presence of a catalyst as the active site and therefore is not essentially considered to be adhesive to the substrate. When the unevenness of the substrate surface is great, the adhesion is favorably maintained by the anchor effect, but as the board surface becomes smooth, naturally, the adhesion tends to become weaker.

Hence, a step for making the surface of the insulating substrate rough is necessary in the semi-additive process and usually, unevenness of approximately 3 to 5 μm based on 10 point average roughness (Rz) is created. This unevenness on the substrate surface is not a practical problem when the line/space value of the circuit to be formed is at least 30 μm/30 μm. However, the unevenness is a great problem in forming a circuit with a line width of at most 30 μm/30 μm particularly at most 25 μm/25 μm, as this high-density circuit line width is influenced by the unevenness of the board surface.

Therefore, in forming a circuit with a line/space value of at most 25 μm/25 μm, the technical art of forming a circuit on an insulating substrate with a smooth surface is necessary. The flatness is preferably at most 1 μm, more preferably at most 0.5 μm on a Rz value basis. Obviously, adhesion by the anchor effect becomes weak in this case and so the development of an alternative adhesion method becomes necessary.

The second problem of the semi-additive process lies in the etching step. The electroless plating copper layer used as the feeding layer for electroplating is a layer unnecessary for the circuit and must be removed by etching after the electroplating layer is formed. However, when the electroless plating copper layer (first metal coating) is removed by etching, the electroplated layer (second metal coating) is also etched. The circuit pattern also decreases in width and thickness and producing an accurate circuit pattern with good reproductivity becomes difficult. Especially when the unevenness of the insulating substrate surface is great, metal such as the electroless plating copper remains in the concave portion of the uneven part and in order to completely remove the metal, time for etching must be taken thoroughly. This results in excessive etching of the metal having the circuit (second metal coating) which should not be etched and causes a decrease in circuit pattern width, change in section shape of the circuit and in severe cases, breaking of the circuit pattern.

The third problem is that because the plating catalyst often remains on the surface of the polymer film, the insulation properties of the obtained printed wiring board tends to decrease and furthermore, when nickel plating and gold plating to the circuit is conducted in the final step, due to the action of the remnant plating catalyst, the circuit cannot be formed because nickel and gold is plated onto the surface of the polymer film.

For this reason, the plating catalyst on the surface of the polymer film is also removed, by removing the first metal coating by etching using an etchant with high etching ability.

However, when removing the electroless plating copper layer using an etchant with high etching ability, etching is conducted excessively and the problems mentioned above also arise here.

Conventionally, the method of alternately laminating a plurality of wiring boards, which have a circuit pattern (inner layer circuit board), and a plurality of pre-preg sheets, which are B-staged by immersing glass cloth in epoxy resin (insulation adhesive layer), followed by pressing and after heating and pressing, conducting between the wiring boards by forming a through hole was known as the method for preparing a multi-layer printed wiring board. However, in this method, because heating and pressing are conducted, a long production time as well as large-scale facilities become necessary and thus production costs increase. Furthermore, there are problems such as a limitation in the thinning of the pre-preg sheet because glass cloth of a relatively high dielectric constant is used as the pre-preg sheet and uncertainty in insulation properties.

As a method to solve the problems mentioned above, the method for preparing a build-up multi-layer printed wiring board, by laminating an organic insulating layer and a metal layer, which has a circuit pattern, in sequence onto the metal layer of the inner layer circuit board, has been attracting attention in recent years.

For example, JP-A-7-202418 and JP-A-7-202426 disclose the method of applying (laminating) copper foil with an adhesive to the inner layer circuit board and then hardening the adhesive. JP-A-6-108016 discloses the method of using adhesive film containing plating catalyst in the additive process and JP-A-7-304933 discloses the method of forming a metal layer by electroless plating or electroplating of copper on the adhesive layer formed on the inner layer circuit board.

Furthermore, JP-A-9-296156 discloses the method for preparing a multi-layer printed wiring board which uses interlayer adhesive film for a multi-layer printed wiring board, made by forming a thin metal layer of 0.05 to 5 μm in thickness on the adhesive film layer which has heat flowability by vacuum vapor deposition, sputtering or ion plating.

However, these conventional methods have the following problems. That is, in the methods disclosed in JP-A-7-202418 and JP-A-7-202426, because copper foil is used, there is a limitation on thinning the copper foil in order to maintain strength and in addition when the through hole is subjected to plating, the thickness of the copper foil increases further. Therefore, these methods have problems such as being unsuitable for preparing a multi-layer printed wiring board having a fine pattern (microscopic circuit pattern). In the methods disclosed in JP-A-6-108016 and JP-A-7-304933, a step of making the surface of the adhesive layer rough is necessary as a preliminary step in order to form a metal layer excellent in adhesion and can withstand practical use. However, the process management of this step is difficult. Also, there are problems such as the interface of the metal layer and the adhesive layer is not smooth and satisfying various properties required in the insulating adhesion layer, such as heat resistance and electric properties, is difficult because the adhesive layer contains organic and inorganic roughened components.

In the method disclosed in JP-A-9-296156, a single layer of adhesive film, which has heat flowability is used as the insulating layer and there is the problem that controlling the thinness and evenness of this layer is difficult.

In short, due to limitation in thinning the metal layer, problem in the adhesion of the metal layer or problem in making the insulating layer thin, preparing a multi-layer printed wiring board having a fine pattern, particularly a circuit pattern by the semi-additive process, is difficult in the conventional methods.

### DISCLOSURE OF INVENTION

The present invention has been made in order to improve the above problems and aims at forming a fine metal circuit layer firmly adhered to polymer film with excellent surface smoothness, in the process of preparing a printed wiring board by the semi-additive method.

The present invention also aims at providing a process for preparing a printed wiring board, capable of forming such a fine metal wiring with keeping the deformation of circuit to the lowest level during the etching step, while ensuring interlayer insulating properties by enabling the removal of the feeding electrode layer during the etching step.

Another object of the present invention is to provide a process for preparing a multi-layer printed wiring board on which a fine pattern, especially a circuit pattern by semi-additive process is formed, easily at a low cost, and a build-up multi-layer printed wiring board obtained by the process; and an interlayer adhesive film to be used for the multi-layered printed wiring board, which provides excellent adhesion between the insulating layer and the metal layer.

That is, the first laminate of the present invention is a laminate comprising a metal layer A having a thickness of at most 1,000 nm, which is laminated at least on one face of a polymer film.

The second laminate of the present invention is a laminate comprising a metal layer A having a thickness of at most 1,000 nm on one face of a polymer film and an adhesive layer on the other face of the polymer film.

The third laminate of the present invention is a laminate such that in the first or second laminate, the metal layer A is formed by dry plating method.

The forth laminate of the present invention is a laminate such that in the first or second laminate, the metal layer A is copper or a copper alloy formed by ion-plating method.

The fifth laminate of the present invention is a laminate such that in the first or second laminate, the metal layer A comprises a metal layer A1 which contacts with the polymer film and a metal layer A2 formed on the metal layer A1.

The sixth laminate of the present invention is a laminate such that in the fifth laminate, the metal layer Al has a thickness of 2 to 200 nm.

The seventh laminate of the present invention is a laminate such that in the fifth laminate, the metal layer A2 has a thickness of 10 to 300 nm.

The eighth laminate of the present invention is a laminate such that in the fifth laminate, the metal layer A1 and the metal layer A2 comprise copper or a copper alloy formed by two different kinds of physical methods.

The ninth laminate of the present invention is a laminate such that in the eighth laminate, the metal layer A1 is copper or a copper alloy formed by ion-plating method.

The tenth laminate of the present invention is a laminate such that in the eighth laminate, the metal layer A2 is copper or a copper alloy formed by sputtering method.

The eleventh laminate of the present invention is a laminate such that in the fifth laminate, the metal layer A1 comprises one kind of metal and the metal layer A2 comprises another kind of metal.

The twelfth laminate of the present invention is a laminate such that in the eleventh laminate, the metal layer A1 comprises nickel or an alloy thereof and the metal layer A2 comprises copper or an alloy thereof.

The thirteenth laminate of the present invention is a laminate such that in the eleventh laminate, the metal layer A is formed by sputtering method.

The fourteenth laminate of the present invention is a laminate such that in the eleventh laminate, the laminate has no oxide layer between the metal layer A1 and the metal layer A2.

The fifteenth laminate of the present invention is a laminate such that in the first or second laminate, the surface of the polymer film has a ten point average roughness of at most 3 μm.

The sixteenth laminate of the present invention is a laminate such that in the first or second laminate, the surface of the polymer film has a dielectric constant of at most 3.5 and a dielectric loss tangent factor of at most 0.02.

The seventeenth laminate of the present invention is a laminate such that in the first or second laminate, the polymer film contains a non-thermoplastic polyimide resin component.

The eighteenth laminate of the present invention is a laminate such that in the second laminate, the adhesive layer comprises an adhesive containing a thermoplastic polyimide resin.

The nineteenth laminate of the present invention is a laminate such that in the second laminate, the adhesive layer comprises a polyimide resin and a thermosetting resin.

The twentieth laminate of the present invention is a laminate such that in the first or second laminate, the laminate has a protective film on the metal layer A.

The twenty-first laminate of the present invention is a laminate such that in the first or second laminate, the metal layer A has a peeling strength of at least 5 N/cm.

The first process of the present invention is a process for preparing a printed wiring board, which comprises forming, on a polymer film, a printed wiring board having a pattern by a first metal coating and a second metal coating, by semi-additive method, wherein an etchant such that the etching rate for the first metal coating is at least 10 times the etching rate for the second metal coating is used.

The second process of the present invention is such that in the first process, the first metal coating is at least one metal selected from the group consisting of nickel, chromium, titanium, aluminum, tin, and alloys thereof, and the second metal coating is selected from the group consisting of copper and alloys thereof.

The first process of the present invention is a process for preparing a printed wiring board, which comprises forming a circuit by using the first or second laminate.

The second process of the present invention is a process for preparing a printed wiring board, which comprises forming a through hole in the first laminate and then carrying out electroless plating.

The third process of the present invention is a process for preparing a printed wiring board, which comprises laminating a conductive foil on the adhesive layer of the laminate of claim 1, forming a through hole, and then carrying out electroless plating.

The fourth process of the present invention is a process for preparing a multi-layer printed wiring board, which comprises facing the adhesive layer of the second laminate with the circuit face of an inner layer circuit board having a circuit pattern, and then carrying out heating and/or pressing, thereby laminating the laminate and the inner layer circuit board.

The fifth process of the present invention is a process such that in the fourth process, the process further comprises steps of making a through hole leading to the electrode on the inner layer circuit board from the surface of the metal layer of the laminate; and panel-plating by electroless plating.

The sixth process of the present invention is a process such that in the second, third or fifth process, the process further comprises a desmear process step after making a through hole.

The seventh process of the present invention is a process such that in the sixth process, the desmear process is dry desmear.

The eighth process of the present invention is a process such that in the fifth process, the process further comprises the steps of: forming a resist pattern using photosensitive plating resist; forming a circuit pattern by electroplating; removing the resist pattern; and removing the electroless plating layer exposed by removing of the resist pattern and the metal layer A by etching.

The ninth process of the present invention is a process such that in the eighth process, the resist pattern forming step is carried out by using a dry film resist.

The tenth process of the present invention is a process such that in the fourth process, the laminate and the inner layer circuit board are laminated by using vacuum pressing machine at most 10 kPa.

The eleventh process of the present invention is a process such that in the fifth process, the through hole making step is carried out by using a laser drilling system.

The twelfth process of the present invention is a process such that in the eighth process, an etchant such that etching thickness of electroplated layer per time required to remove the electroless plating layer exposed by resist pattern removal and metal layer A is smaller than the total thickness of the electroless plating layer and the metal layer A is used.

### BRIEF DESCRIPTION OF DRAWING

FIG. 1 is a view explaining the process for preparing a circuit substrate using the laminate of the present invention.

FIG. 2 is a view explaining the process for preparing the build-up multi-layer printed wiring board of the present invention.

FIG. 3 is a view explaining the process for preparing the build-up multi-layer printed wiring board of the present invention.

### BEST MODE FOR CARRYING OUT THE INVENTION

The laminate of the present invention comprises a metal layer A having a thickness of at most 1,000 nm, which is laminated on at least one face of a polymer film.

The laminate of the present invention may also comprise a metal layer A formed by dry plating method on one face of a polymer film and an adhesive layer on the other face of the polymer film. A laminate of this structure is suitable for preparing a multi-layer printed wiring board as the adhesive layer is faced with the inner board having a circuit in lamination.

The polymer film, metal layer A and adhesive layer constituting the laminate of the present invention is described in detail below.

<Polymer Film>

The surface of the polymer film used in the present invention has a ten point average roughness (hereinafter Rz) of preferably at most 3 μm, more preferably at most 1 μm, most preferably at most 0.5 μm. A polymer film having a Rz value of at most 3 μm can also be effectively applied in the present invention but creates the problem of making the removal of feeding electrode difficult, in the etching step of the semi-additive process. That is, in order to completely remove the feeding electrode, the feeding electrode attached to the interior of the uneven part on the surface must be removed as well, but if etching is conducted over a long period of time, the circuit pattern layer formed by electroplating is etched as well, creating a new problem. As a result, the circuit width and thickness may be smaller than the planned value and in extreme cases, the circuit may even disappear. A smooth surface is suitable for forming a high-density circuit having line/space of at most 25 μm/25 μm and also from the point that there is little etching remnant on the unevenness of the resin surface in the etching step. Rz is defined in JIS B0601 or the like which describes the standard of surface shape. The sensing pin type surface roughness meter of JIS B0651 or the lightwave interfering type surface roughness meter of JIS B0652 may be used to measure Rz. In the present invention, the ten point average roughness of the polymer film is measured using the lightwave interfering type surface roughness meter New View 5030 System made by ZYGO Co.

The dielectric constant of the polymer film is preferably at most 3.5, more preferably at most 3.2, most preferably at most 3.0, and the dielectric loss tangent is preferably at most 0.02, more preferably at most 0.015, most preferably at most 0.01. This is called for from the viewpoints of making the transmission signal a high frequency, speeding up the transmission signal and a decrease in transmission loss. Dielectric properties are dependent on frequency, and in the present invention, the dielectric constant and the dielectric loss tangent are those in a high frequency of MHz range to GHz range. Various methods have been suggested as the measuring method, but the cavity resonator method is superior from the points of stability and reproductivity of measurement. In the present invention, the dielectric properties were measured by the cavity resonator method using MOA2012 (made by KS Systems) at a measurement frequency of 12.5 GHz.

The thickness of the polymer film is preferably 5 to 125 μm, more preferably 10 to 50 μm, most preferably 10 to 25 μm. When the thickness is thinner than this range, the laminate lacks rigidity and handling properties decrease. Also, problems, such as a decrease in electrical insulation between the layers, arise. On the other hand, when the film is too thick, not only is the trend of thinning printed wiring boards countered, but also, when controlling the characteristic impedance of the circuit, the circuit width needs to be widened as the insulation layer becomes thick. This cannot be accepted in the call for the miniaturization and high densification of printed wiring boards.

The polymer of the present invention may be used in the form of board, sheet or film. Examples of the polymer include thermosetting resin, such as epoxy resin, phenol resin, polyamide resin, polyimide resin, unsaturated polyester resin, polyphenylene ether resin and polyphenylene sulfide. In addition, polyester resin, cyanate ester resin, benzocyclobutene and liquid crystal polymer may be effectively used. Furthermore, a board of a resin to which an inorganic filler is compounded or a board, sheet or film to which a base material such as cloth of inorganic fiber including glass or of organic fiber including polyester, polyamide and cotton, or paper is adhered by the aforesaid resin, may also be used effectively. Of these, from the viewpoint of heat resistance, chemical resistance, flexibility, dimensional stability, dielectric constant, electric properties, processability and cost, polyimide resin, epoxy resin or a blend thereof are preferable and polyimide film is the most preferable.

The polymer film may have a conductor circuit or through hole in the interior. Furthermore, in order to improve the peeling strength of the polymer film from the metal layer A, the surface of the polymer film may be subjected to roughening treatment or various known surface treatment such as corona discharge treatment, plasma treatment, flame treatment, heat treatment, primer treatment and ion bombardment treatment. Usually when the polymer film is exposed to air after these treatments, the modified surface is deactivated and the effects of the treatment decrease considerably. Therefore, it is preferable that these treatments are conducted in vacuum and successively, metal layer A is formed in vacuum. Furthermore, adding a known tackifier or conducting surface treatment to the resin constituting the polymer film is also effective.

The case of using polyimide as the polymer film is described in detail below.

The polyimide film is not particularly limited and polyimide film prepared by various known methods may be used. The polyimide film can be obtained by forming a polyamic acid film (hereinafter gel film) by partially imidizing or partially drying to a self supporting degree from a solution of a polyamic acid polymer, then heating the gel film and completely imidizing the polyamic acid. The solution of polyamic acid polymer is obtained by polymerizing practically equal mole of a tetracarboxylic acid dianhydride component, comprising at least one kind of tetracarboxylic acid dianhydride and a diamine component, comprising at least one kind of diamine, in an organic polar solvent. The obtained polyimide film does not have heat flowability.

Examples of tetracarboxylic acid dianhydride suitable for obtaining the polyamic acid polymer for preparing the polyimide film are aromatic tetracarboxylic acid dianhydrides such as pyromellitic acid dianhydride, 3,3′,4,4′-benzophenonetetracarboxylic acid dianhydride, 3,3′,4,4′-diphenylsulfonetetracarboxylic acid dianhydride, 1,4,5,8-naphthalenetetracaboxylic acid dianhydride, 2,3,6,7-naphthalenetetracarboxilic acid dianhydride, 4,4′-oxydiphthalic acid dianhydride, 3,3′,4,4′-dimethyldiphenylsilanetetracarboxylic acid dianhydride, 3,3′,4,4′-tetraphenylsilanetetracarboxylic acid dianhydride, 2,3,4,5-furantetracarboxylic acid dianhydride, 4,4′-bis(3,4-dicarboxyphenoxy)diphenylpropane dianhydride, 4,4′-hexafluoroisopropylidenediphthalic acid dianhydride, 3,3′,4,4′-biphenyltetracarboxylic acid dianhydride, 2,3,3′,4′-biphenyltetracarboxylic acid dianhydride, p-phenylenediphthalic acid dianhydride and p-phenylenebis(trimellitic acid monoester dianhydride). These tetracarboxylic acid dianhydride are not particularly limited and may be used alone or in combination of two or more. Of the examples of tetracarboxylic acid dianhydride given above, using pyromellitic acid dianhydride and p-phenylenebis(trimellitic acid monoester anhydride) together in any ratio, that is using these tetracarboxylic acid dianhydride together in any ratio as the tetracarboxylic acid dianhydride component, is preferable.

Examples of diamine suitable for obtaining the polyamic acid polymer for preparing the polyimide film are aromatic diamine or aliphatic diamine such as 4,4′-diaminodiphenyl ether, 3,4′-diaminodiphenyl ether, 2,2-bis(4-aminophenoxyphenyl)propane, 1,4-bis(4-aminophenoxy)benzene, 1,3-bis(4-aminophenoxy)benzene, 1,3-bis(3-aminophenoxy)benzene, bis{4-(4-aminophenoxy)phenyl}sulfone, bis{4-(3-aminophenoxy)phenyl}sulfone, 4,4′-bis(4-aminophenoxy)biphenyl, 2,2-bis{4-(4-aminophenoxy)phenyl}hexafluoropropane, 4,4′-diaminodiphenylsulfone, 3,3′-diaminodiphenylsulfone, 9,9-bis(4-aminophenyl)fluorene, bisaminophenoxy ketone, 4,4′-{1,4-phenylenebis(1-methylethylidene)}bisaniline, 4,4′-{1,3-phenylenebis(1-methylethylidene)}bisaniline, m-phenylenediamine, p-phenylenediamine, 4,4′-diaminobenzanilide, 3,3′-dimethyl-4,4′-diaminobiphenyl, 3,3′-dimetoxy-4,4′-diaminobiphenyl, 3,3′-dimethylbenzidine and 3,3′-dihydroxybenzidine. These diamine are not particularly limited and may be used alone or in combination of two or more. Of the examples of diamine given above, using p-phenylenediamine, 4,4′-diaminobenzanilide and 4,4′-diaminodiphenyl ether together in any ratio, that is using these diamine together in any ratio as the diamine component, is preferable.

The specific combination and compounding ratio when using at least two kinds of tetracarboxylic acid dianhydride together, the specific combination and compounding ratio when using at least two kinds of diamine together and the specific combination of the tetracarboxylic acid dianhydride component and the diamine component are not particularly limited. In short, the above exemplification are examples and the most suitable combination and compounding ratio may be selected according to the desired properties of the polyimide film.

Examples of the organic polar solvent suitable for obtaining the polyamic acid polymer for preparing the polyimide film are sulfoxide solvents such as dimethyl sulfoxide and diethyl sulfoxide; formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; phenol solvents such as phenol, o-, m- or p-cresol, xylenol, halogenated phenol and catechol; hexamethylphosphoramide; y-butyrolactone; dioxolan; and the like. These organic polar solvents may be used alone or in combination of two or more. Further, as long as the polymerization is not hindered, these organic polar solvents may be used in combination with an aromatic hydrocarbon such as toluene or xylene.

When adding the tetracarboxylic acid dianhydride component and the diamine component to the organic polar solvent and polymerizing, the method (order) of adding and the method of polymerization are not particularly limited and various known methods may be employed. For example, the solution of polyamic acid polymer may be obtained by carrying out polymerization while gradually adding the tetracarboxylic acid dianhydride component to the organic polar solvent into which the diamine component is dissolved. Also, the solution of polyamic acid polymer may be obtained by carrying out polymerization while adding the tetracarboxylic acid dianhydride component and the diamine component simultaneously to the organic polar solvent, or by carrying out polymerization while adding the tetracarboxylic acid dianhydride component and the diamine component alternately to the organic polar solvent. The polymerization conditions are not particularly limited. Furthermore, when at least 2 kinds of tetracarboxylic acid dianhydride and/or diamine are used together, in other words when at least three kinds of monomers are to be copolymerized, the molecular structure (monomer sequence) of the obtained polyamic acid polymer can be controlled by accordingly changing the order in which each monomer is added. The method for copolymerizing at least 3 kinds of monomers are for example random copolymerization, block copolymerization, partial copolymerization and sequential copolymerization.

When obtaining a solution of a polyamic acid polymer, processes such as filtration may be conducted in order to remove the extraneous substances and high molecular weight substances within the solution in any step, for example before, during or after polymerization, more specifically at any point before the gel film forming step is conducted. Furthermore, in order to cut down on the time necessary for the polymerization step, the polymerization step may be conducted divided into the first polymerization step, in which a pre-polymer having a low polymerization degree is obtained, and the second polymerization step, in which a polyamic acid polymer having a high molecular weight is obtained. Particularly, in order to improve the polymerization and filtration efficiency, it is preferable that processes such as filtration are conducted at the stage of pre-polymer obtained by the first polymerization step, and then the second polymerization step is conducted.

Also, complex polyimide film can be prepared by adding various organic additives, inorganic fillers or various reinforcements to the solution of a polyamic acid polymer at any point before the gel film forming step is conducted.

The ratio (concentration) of the polyamic acid polymer within the solution is not particularly limited but is preferably within the range of 5 to 40% by weight, more preferably 10 to 30% by weight, in view of handling.

The average molecular weight of the polyamic acid polymer is preferably within the range of 10,000 to 1,000,000. When the average molecular weight is less than 10,000, the obtained polyimide film may be brittle. When the average molecular weight exceeds 1,000,000, the viscosity of the solution of polyamic acid polymer becomes too high and handling may become difficult.

The method for forming the gel film from the solution of polyamic acid polymer obtained by the above method and the method for preparing the polyimide film from the gel film are not particularly limited. The polyimide film may be prepared by various known methods. Specifically, for example, after forming the gel film by casting or applying the solution of polyamic acid polymer to a support such as a glass board or a stainless belt, the polyimide film can be obtained by heating the gel film. When heating the gel film, after peeling the gel film from the base, the end of the gel film can be fastened using a pin or clip.

Examples of methods for imidizing the polyamic acid polymer are the chemical cure method and heat cure method. Considering the productivity of the polyimide film and the properties desired in the polyimide film, the chemical cure method or joint use of the chemical cure method and the heat cure method is preferable. When employing the chemical cure method, a curing agent (hereinafter chemical curing agent) obtained by mixing a dehydrating agent and catalyst which advance the imidizing reaction with a solvent such as a organic polar solvent, is added and then mixing and stirring is conducted, at any point before the gel film forming step is carried out.

Because the gel film is in the midst of the drying phase, the gel film contains a solvent such as an organic polar solvent. The content of the volatile component (the amount of the solvent) in the gel film is calculated from the equation (1) below.

Content of volatile component (% by weight)={(A-B)/B}×100 (1)

(In the equation (1), A represents the weight of the gel film and B represents the weight of the gel film after heating for 20 minutes at 450° C.)

The content of the volatile component is within the range of 5 to 300% by weight, preferably 5 to 100% by weight, and more preferably 5 to 50% by weight.

Furthermore, the gel film is in the midst of the imidizing reaction phase from a polyamic acid polymer to a polyimide. The imidization ratio which indicates the progression of the reaction can be measured by an infrared absorption spectrometry and calculated from the equation (2).

Imidization ratio (%)={(C/D)/(E/F)}×100 (2)

(In the equation (2), C represents the absorption peak height of the gel film at 1,370 cm⁻¹, D represents the absorption peak height of the gel film at 1,500 cm⁻¹, E represents the absorption peak height of the polyimide film at 1370 cm⁻¹ and F represents the absorption peak height of the polyimide film at 1370 cm⁻¹.)

The imidization ratio is preferably at least 50%, more preferably at least 70%, further preferably 80% or higher, and most preferably at least 85%.

According to the above method, the thickness of the polyimide film can be controlled to be thin and even. The polyimide film obtained by the above methods may be subjected to various treatments such as known surface treatments or post-treatments. Examples of the treatment are emboss treatment, sandblast treatment, corona discharge treatment, plasma discharge treatment, electron irradiation treatment, UV treatment, heat treatment, flame treatment, solvent cleaning treatment, primer treatment and chemical etching treatment. A plurality of these treatments may be combined according to need. The polyimide film can be prepared from the gel film after the gel film is subjected to one kind or a combination of a plurality of these treatments.

In order to further improve the adhesion between the polyimide film and the metal layer or the adhesive layer, it is preferable that the gel film is immersed in a solution of a compound containing at least one element selected from the group consisting of Al, Si, Ti, Mn, Fe, Co, Cu, Zn, Sn, Sb, Pb, Bi and Pd (hereinafter element group) or the solution is applied to the gel film, and then the gel film is completely dried and the polyamic acid polymer is imidized. Si and Ti are particularly preferred among the element group.

The compounds containing the above element group are inorganic compounds or organic compounds. Examples of the inorganic compounds are for example, halogenides such as chlorides and bromides, oxides, hydroxides, carbonates, nitrates, nitrites, phosphates, sulfates, silicates, borates and condensed phosphates. Examples of the organic compounds are for example neutral molecules such as alkoxides, acylates, chelates, diamines and diphosphines; ionic molecules containing acetylacetonate ion, carboxylic acid ion or dithiocarbamic acid ion, cyclic legands such as porphyrin and metal complex salt. Among the above compounds, alkoxides, acylates, chelates and metal complex salt are preferable, particularly these compounds which contain Si or Ti.

Examples of the compound containing Si (silicon compound) are aminosilane-based compounds such as N-β-(aminoethyl)-γ-aminopropyltrimethoxysilane, N-β(aminoethyl)-γ-aminopropylmethyldimethoxysilane, N-phenyl-γ-aminopropyltrimethoxysilane, γ-aminopropyltriethoxysilane; and epoxysilane-based compounds such as β-(3,4-epoxycyclohexyl)ethyltimethoxysilane, γ-glycidoxypropyltrimethoxysilane, γ-glycidoxypropylmethyldimethoxysilane, but are not particularly limited to these.

The compound containing Ti (titanium compounds) is preferably a compound represented by the following formula (I)

(R¹O)ₘ—Ti—(OX)₄₋ₘ (I)

(wherein m is an integer of 0 to 4; R¹ is H or a hydrocarbon group having 3 to 18 carbon atoms; and X is

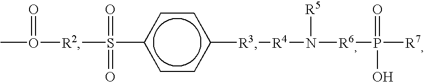

or a group containing a carboxylic acid having 3 to 18 carbon atoms or an ammonium salt thereof; R² is a hydrocarbon group having 3 to 18 carbon atoms, R³ is a hydrocarbon group having 3 to 18 carbon atoms, R⁴ is a hydrocarbon group having 3 to 18 carbon atoms, and R⁵ and R⁶ are independently hydrocarbon group having 3 to 18 carbon atoms; R⁷is a hydrocarbon group having 3 to 18 carbon atoms or

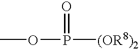

and R⁸ is a hydrocarbon group having 2 to 18 carbon atoms), but is not particularly limited. Examples of the compounds indicated in the formula (I) are tri-n-butoxytitanium monostearate, diisopropoxytitanium bis(triethanolaminate), butyltitanate dimer, tetra-n-butyltitanate, tetra(2-ethylhexyl)titanate, titanium octylene glycolate, dihydroxy-bis(ammonium lactate) titanium and dihydroxytitanium bislactate. Of these, tri-n-butoxytitanium monostearate and dihydroxytitanium bislactate are particularly preferred.

Examples of the solvent suitable for preparing the solution of the compound are for example, water, toluene, xylene, tetrahydrofuran, 2-propanol, 1-butanol, ethyl acetate, N,N-dimethylformamide and acetylacetone. The solvent is not particularly limited and may be any solvent which can dissolve the compound. These solvents may be used alone or by mixing two or more of them. Of these solvents, water, 2-propabol, 1-butanol and N,N-dimethylformamide are especially preferable. Also, a chemical cure agent may also be added to the solution of the compound.

The concentration of the element group within the solution is preferably within the range of 1 to 100,000 ppm, more preferably within the range of 10 to 50,000 ppm. Therefore, though depending on the type (molecular weight) of compound, the concentration of the compound containing the element groups within the solution is preferably 0.001 to 100% by weight, more preferably 0.01 to 10% by weight, most preferably 0.1 to 5% by weight.

By immersing the gel film in the solution of the compound or applying the solution to the gel film and then removing excess droplets on the gel film surface, polyimide film with improved adhesion and superior appearance without unevenness on the surface can be obtained. To remove the droplets, a known method using a nip roll, an air knife or a doctor blade can be employed, and of these, the method using a nip roll is preferably used in view of the droplet removal, workability and appearance of the obtained polyimide film.

In the present invention, the thickness of the polyimide film is not particularly limited, but preferably within the range of 5 to 125 μm. Particularly when used for a multi-layer printed wiring board, the thickness is preferably within the range of 10 to 75 μm, more preferably 10 to 50 μm. The tensile modulus of the polyimide film is preferably at least 4 GPa, more preferably at least 6 GPa, most preferably 10 GPa. The linear expansion coefficient of the polyimide film is preferably at most 17 ppm, more preferably at most 12 ppm, most preferably at most 10 ppm. The water absorption of the polyimide film is preferably at most 2%, more preferably at most 1.5%, most preferably at most 1%.

<Metal Layer A>

The metal layer A of the present invention is described in detail below. The metal layer A is formed on at least one face of the polymer film and when the electroless plating is carried out in the panel plating step, the metal layer A has the function of adhering firmly to the electroless plating layer. Needless to say, the polymer film and metal layer A also need to be firmly adhered.

The dry plating method is preferred as the method for forming metal layer A. The dry plating method does not require the application of a plating catalyst to the polymer film in order to form metal layer A and does not leave plating catalyst on the polymer film and is therefore preferable. For example, when conducting electroless plating, because plating catalyst is present on the metal layer A and afterwards in the etching step, the catalyst is washed off along with the metal layer A, a laminate with superior electric insulation can be obtained, compared to the conventional method of conducting electroless plating by applying the electroless plating catalyst directly to the resin material. Furthermore, there is no need to conduct surface roughening treatment (desmear process) for improving adhesion as in wet electroless plating and the interface of the metal coating and the insulating substrate becomes smooth, providing good influence for the formation of narrow circuits and electric properties. As methods for forming the metal layer A according to the dry plating method, the vacuum vapor deposition method, sputtering method, ion plating method and the CVD method may be applied.

Of these, a metal layer formed by physical vapor deposition is preferable in that good adhesive properties can be obtained. Examples of physical vapor deposition methods are vacuum vapor deposition methods such as resistor heating vapor deposition, EB vapor deposition, cluster ion beam vapor deposition and ion plating vapor deposition and sputtering methods such as RF sputtering, DC sputtering, magnetron sputtering and ion beam sputtering. Any of these methods are applicable to the present invention, including a combination of these methods.

Furthermore, of these, a sputtering method, particularly DC sputtering, is preferable in terms of adhesion strength between the polymer film and metal layer A and simplicity, productivity and cost of facilities. Ion plating vapor deposition is also preferable as it has fast film production speed, is industrially advantageous and provides good adhesion.

The case of using sputtering is described further. A known method may be used for sputtering. In other words, DC magnetron sputter, RF sputter or these methods improved in various ways may be used according to need. For example, DC magnetron sputter is preferable in order to efficiently sputter conductors such as nickel and copper. On the other hand, when sputtering in a high vacuum to prevent the mixing of sputter gas in the thin film, RF sputter is suitable.

More specifically, in DC magnetron sputter, the polymer film as the substrate is first set into the vacuum chamber and then evacuation is conducted. Usually, a rotating pump (rough vacuum) and a diffusion pump, cryopump or turbopump are combined to evacuate to 6×10⁻⁴ Pa or less. Then, sputter gas is introduced to set the pressure within the chamber to 0.1 to 10 Pa, more preferably 0.1 to 1 Pa, and plasma discharge is caused by applying DC voltage to the metal target. At this time, by forming a magnetic field on the target and locking the generated plasma in the magnetic field, the sputter efficiency of the plasma particles to the target becomes high. Without influencing the polymer film with plasma or sputter, the metal target is held in the state of when plasma was generated for a few minutes to a few hours and the oxide layer on the surface of the metal target is removed (pre-sputter). After pre-sputtering is finished, the shutters are opened and sputter is conducted to the polymer film. The discharge power when sputtering is preferably within the range of 100 to 1,000 watts. Depending on the shape of the sample to be sputtered, batch sputter or roll sputter may be applied. The sputter gas to be introduced is usually inert gas such as argon, but mixed gas containing a small amount of oxygen or other gas may be used.

It is important that the metal to be used for metal layer A is a metal which has high adhesion strength to the polymer film and the circuit pattern later formed on metal layer A in the preparation step of the wiring board and which can be completely removed in the etching step of the process for preparing the printed wiring board of the present invention.

For example, metal such as copper, nickel, chrome, titanium, nichrome, molybdenum, tungsten, zinc, tin, indium and aluminum or an alloy thereof may be used and metal layer A may be composed of a single layer or two or more layers of these.

In one embodiment of metal layer A of the present invention, though copper is preferable as the metal material which composes metal layer A, at least one kind of metal selected from the group consisting of nickel, chrome, silver, aluminum, titanium and silicone, and copper are used. More specifically, metal layer A may comprise (i) copper, (ii) an alloy (complex) containing at least one kind of metal selected from the above group and copper or (iii) a two layer structure of one layer containing at least one kind of metal selected from the above group and a layer of copper.

The thickness of metal layer A may be set according to need but is at most 1,000 nm, preferably 2 to 1,000 nm, more preferably 2 to 500 nm. When the thickness of metal layer A is set to less than 2 nm, stable peeling strength may not be obtained. Setting the thickness of the metal layer to be thicker than 1,000 nm is not suitable for preparing a multi-layer printed wiring board with a fine pattern, for the same reason in the case of copper foil with an adhesive agent which is a prior art. Particularly when preparing a multi-layer printed wiring board by forming a circuit pattern by the semi-additive method, the thickness of the metal layer is most preferably set to at most 1,000 nm.

In another embodiment of metal layer A of the present invention, metal layer A is of a two layer structure of two kinds of metal layers and the thickness of each layer are respectively controlled to a suitable thickness. Here, the metal layer formed directly on the polymer film is metal layer A1 and the metal layer formed on this layer is metal layer A2. By forming two kinds of metal layers, the etching properties, adhesion properties to the polymer film and peeling strength from the electroless plating coating or the electroplated coating can be improved. That is, for the metal layer A1 which is formed directly on the polymer film, a metal that is effective for maintaining good adhesion with the polymer film is selected. On the other hand, for the metal layer A2 which is formed on metal layer A1, selecting a metal which can firmly adhere to the electroplated layer formed directly on A2 or to the electroless plating layer formed in the panel plating step is effective.

As metal used for metal layer A1, copper, nickel, chrome, tin, titanium, and aluminum are preferable and nickel is particularly preferable. The thickness of metal layer A1 is preferably between the range of 2 to 200 nm, more preferably 3 to 100 nm, most preferably 3 to 30 nm. When the thickness is less than 2 nm, sufficient adhesion strength cannot be obtained and this thickness is not preferable. Also, making a coating evenly over the polymer film becomes difficult. On the other hand, when the thickness exceeds 200 nm, extra etching must be conducted in the etching step when preparing the printed wiring board and this thickness is not preferable because the circuit thickness becomes thinner than the planned value, the circuit width becomes narrow, undercut occurs and the circuit shape deteriorates. Furthermore, problems arise, such as peeling or curling of the coating at the interface with A2 due to dimensional change caused by stress within the layer or temperature.

The metal used for metal layer A2 is selected depending on the kind of electroplating or electroless plating formed directly on A2 in the process for preparing the printed wiring board, but as mentioned later, considering that electroless copper plating or electroless nickel plating, particularly electroless copper plating, is preferable as the electroless plating, the metal used for metal layer A2 is preferably nickel or copper, more preferably copper. For improving adhesion strength it is effective that metal layer A2 contains the main component of the metal layer to be formed by the electroless plating in preparing the printed wiring board. The thickness of metal layer A2 is 10 to 300 nm, more preferably 20 to 200 nm, most preferably 50 to 150 nm. When the thickness is less than 10 nm, sufficient adhesion with the electroless plating layer formed in the next step are difficult to maintain. On the other hand, a thickness of at least 200 nm is unnecessary and considering the etching step to follow, the thickness is preferably at most 200 nm.

The total thickness of metal layer A composed of metal layer A1 and metal layer A2, is preferably 20 to 400 nm, more preferably 50 to 200 nm. From the viewpoint that peeling strength becomes higher, metal layer A1 which is formed directly on the polymer film is preferably thinner than A2. By setting the thickness within this range, etching properties when applying the semi-additive process and peeling strength of the metal layer formed by electroless plating and/or electroplating can both be attained. In other words, if the metal layer is too thin, the peeling strength of the metal layer formed by electroless plating and electroplating is small and pattern peeling may be caused. On the other hand, if the metal layer is too thick, extra etching becomes necessary in the etching step and the circuit is also greatly etched when etching the space part. This results in unfavorable deterioration of the circuit such as the circuit thickness becoming thinner than the planned value, the circuit width becoming narrow, undercut occurring or sufficient cross section area not being obtained based on the planned circuit width by the collapse in the shape of the circuit cross section which is normally rectangular. The deterioration in circuit shape decreases the conductivity of the circuit past the planned value and is a cause of circuit malfunction.

For example, strong thin films having a peeling strength of at least 6 N/cm can be formed when polyimide is used as the polymer film and electroless plating of copper is employed as the electroless plating, and when metal layer A1 is a 10 to 100 nm-thick metal layer of nickel, chrome, titanium or an alloy containing these as the main component, and metal layer A2 is a 20 to 200 nm-thick metal layer of copper or a copper alloy, the total thickness of the metal layer composed of these two layers being 30 to 200 nm.

When laminating or forming at least two kinds of metal layers, if an oxide layer forms on each film surface, the adhesion between each of the metals decrease and so dry plating is preferably conducted continuously in vacuum. In this case, vapor deposition and sputtering are preferable as dry plating and of these, sputtering, particularly DC sputtering is preferable.

In yet another embodiment of metal layer A of the present invention, metal layer A is a layer of copper or a copper alloy formed by the ion plating method. This method also improves the adhesion strength of metal layer A with the polymer film or with the circuit pattern later formed on metal layer A in the step for preparing the printed wiring board.

The copper thin film prepared by the ion plating method was discovered to be superior in adhesion to the substrate and to exhibit firm adhesion even to polymer film superior in surface smoothness. The copper alloy mentioned here is an alloy with copper as the main component to which other metal is added and examples of the metal to be added are nickel, chrome and titanium. Particularly, strong copper thin film having a peeling strength of at least 6 N/cm can be formed even to polyimide, which was difficult by the conventional sputtering method.

In still another embodiment of metal layer A of the present invention, metal layer A has a two layer structure of copper or a copper alloy layer formed by at least two different physical techniques. Here, the copper alloy is an alloy with copper as the main component and examples of the metal to be added are nickel, chrome and titanium.

As mentioned above, the copper thin film prepared by the ion plating method is superior in adhesion to the substrate and can exhibit firm adhesion even to polymer film superior in surface smoothness.

However, the copper or copper alloy thin film layer made by the ion plating method alone is low in tolerance of chemical treatment. If a copper thin film is formed on the ion plating coating by the electroless plating process, the film peels off from the polymer film.

So, in the present invention, an attempt was made to form a copper thin film (metal layer A1) by the ion plating method and then further form a copper thin film by the sputtering method. The sputtering method is not particularly limited and methods such as DC magnetron sputtering, high frequency magnetron sputtering and ion beam sputtering may be effectively used.

The copper thin film formed by the ion plating method exhibits firm adhesion with the polymer film. This adhesion did not change even when a copper film was formed on the ion plating film by the sputtering method. Furthermore, the sputtered film is tolerant to chemical treatment and so a plating film was easily formed on the sputtered film by the electroless plating method. That is, the sputtered film is considered to have the role of protecting the ion plating film during the electroless plating process and adhering the electroless plating layer.

<Adhesive Layer>

Regarding the adhesive layer, the type of adhesive agent to be used is not particularly limited and known resin that can be used as an adhesive agent can be applied. The adhesive can largely be divided into (A) thermofusible adhesives using thermoplastic resin and (B) curable type adhesives based on the curing reaction of thermosetting resins. These are explained below.

Examples of the thermoplastic resin which provide thermofusibility to adhesive (A) are polyimide resin, poly(amide imide) resin, poly(ether imide) resin, polyamide resin, polyester resin, polycarbonate resin, polyketone resin, polysulfone resin, polyphenylene ether resin, polyolefin resin, polyphenylene sulfide resin, fluororesin, polyallylate resin and liquid crystal polymer resin. These may be used alone or in combination of two or more as the adhesive layer of the laminate of the present invention. Of these, thermoplastic polyimide resin is preferable from the viewpoint of excellent heat resistance and electric reliability.

Herein, the method of producing thermoplastic polyimide resin is described. The polyimide resin can be obtained from a solution of polyamic acid polymer, which is a precursor of the polyimide. The polyamic acid polymer solution can be produced by a known method. That is, the solution can be obtained by polymerizing practically equal mole of a tetracarboxylic acid dianhydride component and a diamine component in an organic polar solvent.

The acid dianhydride to be used for the thermoplastic polyimide resin is not particularly limited as long as it is an acid dianhydride. Examples of the acid dianhydride component include aliphatic or alicyclic tetracarboxylic acid dianhydrides such as butanetetracarboxylic acid dianhydride, 1,2,3,4-cyclobutanetetracarboxylic acid dianhydride, 1,3-dimethyl-1,2,3,4-cyclobutanetetracarboxylic acid dianhydride, 1,2,3,4-cyclopentanetetracarboxylic acid dianhydride, 2,3,5-tricarboxycyclopentylacetatic acid dianhydride, 3,5,6-tricarboxynorbornane-2-acetic acid dianhydride, 2,3,4,5-tetrahydrofurantetracarboxylic acid dianhydride, 5-(2,5-dioxotetrahydrofuranyl)-3-methyl-3-cyclohexene-1,2-dicarboxylic acid dianhydride, bicyclo[2,2,2]-oct-7-ene-2,3,5,6-tetracarboxylic acid dianhydride; aromatic tetracarboxylic acid dianhydrides such as pyromellitic acid dianhydride, 3,3′,4,4′-benzophenonetetracarboxylic acid dianhydride, 3,3′,4,4′-diphenylsulfonetetracarboxylic acid dianhydride, 1,4,5,8-naphthalenetetracarboxylic acid dianhydride, 2,3,6,7-naphthalenetetracarboxylic acid dianhydride, 4,4′-oxyphthalic acid anhydride, 3,3′,4,4′-dimethyldiphenylsilanetetracarboxylic acid dianhydride, 3,3′,4,4′-tetraphenylsilanetetracarboxylic acid dianhydride, 1,2,3,4-furantetracarboxylic acid dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 4,4′-hexafluoroisopropylidenediphthalic acid anhydride, 3,3′,4,4′-biphenyltetracarboxylic acid dianhydride, 2,3,3′,4′-biphenyltetracarboxylic acid dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, bis(triphenylphthalic acid)-4,4′-diphenylmethane dianhydride; 2,2-bis(4-hydroxyphenyl)propanedibenzoate-3,3′,4,4′-tetracarboxylic acid dianhydride, p-phenylene-bis(trimellitic acid monoester anhydride), 4,4′-biphenylene-bis(trimellitic acid monoester anhydride), 1,4-naphtalene-bis(trimellitic acid monoester anhydride), 1,2-ethylene-bis(trimellitic acid monoester anhydride), 1,3-trimethylene-bis(trimellitic acid monoester anhydride), 1,4-tetramethylene-bis(trimellitic acid monoester anhydride), 1,5-pentamethylene-bis(trimellitic acid monoester anhydride), 1,6-hexamethylene-bis(trimellitic acid monoester anhydride) and 4,4′-(4,4′-isopropylidenediphenoxy)-bis(phthalic anhydride). One kind or combination of two or more of these may be used as the acid dianhydride component in part or in whole.

In order to exhibit excellent thermofusibility, it is preferable to use 2,2-bis(4-hydroxyphenyl)propanedibenzoate-3,3′,4,4′-tetracarboxylic acid dianhydride, 1,2-ethylene-bis(trimellitic acid monoester anhydride), 4,4′-hexafluoroisopropylidenediphthalic acid anhydride, 2,3,3′,4′-biphenyltetracarboxylic acid dianhydride, 4,4′-oxydiphthalic acid anhydride, 3,3′,4,4′-benzophenonetetracarboxylic acid dianhydride and 4,4′-(4,4′-isopropylidenediphenoxy)-bis(phthalic anhydride).

Examples of the diamine component include 4,4′-diaminodiphenyl ether, 3,4′-diaminodiphenyl ether, 2,2-bis[4-(4-aminophenoxy)phenyl]propane, 2,2-bis[3-(3-aminophenoxy)phenyl]propane, 1,4-bis(4-aminophenoxy)benzene, 1,3-bis(4-aminophenoxy)benzene, 1,3-bis(3-aminophenoxy)benzene, bis[4-(4-aminophenoxy)phenyl]sulfone, bis[4-(3-aminophenoxy)phenyl]sulfone, 4,4′-bis(4-aminophenoxy)biphenyl, 2,2-bis(4-aminophenoxyphenyl)hexafluoropropane, 4,4′-diaminodiphenylsulfone, 3,3′-diaminodiphenylsulfone, 9,9-bis(4-aminophenyl)fluorene, bisaminophenoxy ketone, 4,4′-[1,4-phenylenebis(1-methylethylidene)]bisaniline, 4,4′-[1,3-phenylenebis(1-methylethylidene)]bisaniline, 3,3′-dimethylbenzidine and 3,3′-dihydroxybenzidine. These may be used alone or in combination of two or more.

Among these diamine components, as the material for the thermoplastic polyimide resin used for the laminate of the present invention, 1,3-bis(3-aminophenoxy)benzene, 3,3′-dihydroxybenzidine and bis[4-(3-aminophenoxy)phenyl]sulfone are preferred, and these can be used alone or by mixing in any ratio.

A common procedure of the reaction for obtaining a solution of polyamic acid polymer is the method of dissolving or diffusing at least one kind of the diamine component into the organic polar solvent and then adding at least one kind of the acid dianhydride component. The order for adding each monomer is not particularly limited. To obtain the solution of polyamic acid polymer, the acid dianhydride component may first be added to the organic polar solvent, then adding the diamine component, or an appropriate amount of the diamine component may first be added to the organic polar solvent, followed by an excessive amount of the acid dianhydride component, then adding the diamine component in an amount equivalent to the excess amount. There are also other methods known to a person skilled in the art. Herein, besides cases in which the solvent completely dissolves the solute, “dissolve” includes cases in which the solute is evenly dispersed or diffused within the solvent and is practically in the same state as being dissolved.

The organic polar solvent to be employed for the generation reaction of the polyamic acid solution include, for example, sulfoxide solvents such as dimethyl sulfoxide and diethyl sulfoxide; formamide solvents such as N,N-dimethylformamide and N,N-diethylformamide; acetamide solvents such as N,N-dimethylacetamide and N,N-diethylacetamide; pyrrolidone solvents such as N-methyl-2-pyrrolidone and N-vinyl-2-pyrrolidone; phenol solvents such as phenol, o-, m- or p- cresol, xylenol, halogenated phenol and catechol; hexamethylphosphoramide; and γ-butyrolactone. Further, when necessary, these organic polar solvents may be used in combination with an aromatic hydrocarbon such as xylene or toluene.

The method for imidizing the polyamic acid is described next. The imidization reaction of the polyamic acid is dehydration ring closing reaction through which water is generated. This generated water easily hydrolyzes polyamic acid and causes a decrease in molecular weight. As the method for imidizing while removing this water, there are the usual methods of 1) the method of removing by adding an azeotropic solvent such as toluene or xylene and azeotroping, 2) the chemical imidization method of adding aliphatic acid dianhydride such as acetic anhydride and tertiary amine such as triethylamine, pyridine, picoline and isoquinoline and 3) the method of imidizing by heating in vacuum.

The method for imidizing the thermoplastic polyimide resin of the present invention is preferably the method of imidizing by heating in vacuum. By this imidizing method, because the water generated by imidization can be actively removed from the system, hydrolysis of the polyamic acid can be controlled and polyimide of a high molecular weight is obtained. Furthermore, by this method, the ring opening on one or both sides of the element which is present as impurity within the acid dianhydride material closes again and so further improvement effect of the molecular weight can be expected.

As for the heating conditions for the method of imidizing by heating in vacuum, the heating temperature is preferably 80° to 400° C., more preferably at least 100° C. and most preferably at least 120° C. as imidization is conducted efficiently and water is removed efficiently. The highest temperature is preferably at most the thermal decomposition temperature of the polyimide to be obtained and the completion temperature of usual imidization, that is approximately 250° to 350° C., is usually adopted. Regarding the conditions of vacuum, the smaller the pressure, the better. Specifically, the pressure is at most 900 hPa, preferably at most 800 hPa, more preferably at most 700 hPa.

As another method for obtaining thermoplastic polyimide resin, there is a method in which solvent evaporation is not carried out in the above thermal or chemical dehydration ring closing method. More specifically, it is the method of obtaining solid polyimide resin, which comprises adding, to a poor solvent, a polyimide resin solution obtained by thermal imidization treatment or chemical imidization treatment using a dehydration agent to precipitate the polyimide resin, removing unreacted monomers, and then refining and drying. As the poor solvent, one which mixes well with a solvent but to which polyimide is not easily dissolved should be selected. Examples include acetone, methanol, ethanol, isopropanol, benzene, methyl cellosolve and methyl ethyl ketone, but the poor solvent is not limited to these examples. The thermoplastic polyimide resin can be obtained by these methods and used as the adhesive layer of the laminate of the present invention.

The curable type adhesive (B) using the curing reaction of a thermosetting resin is explained next. Examples of the thermosetting resin include bismaleimide resin, bisallylnadiimide resin, phenol resin, cyanate resin, epoxy resin, acrylic resin, methacrylic resin, triazine resin, hydrosilyl curing resin, allyl curing resin and unsaturated polyester resin. These can be used alone or in a combination. Other than the above thermosetting resins, thermosetting polymers containing a reactive group such as an epoxy group, allyl group, vinyl group, alkoxysilyl group or hydrosilyl group in the side chains or terminals of the polymer chains can also be used as the thermosetting component.

The thermosetting polyimide resin containing a reactive group in the side chain is described below. Examples of practical production methods are (1) a method of obtaining thermosetting polyimide according to the method of producing thermoplastic polyimide resin mentioned above, in which a diamine component having a functional group such as an epoxy group, vinyl group, allyl group, methacryl group, acryl group, alkoxysilyl group, hydrosilyl group, carboxy group, hydroxy group or cyano group or an acid dianhydride component is used as the monomer components and (2) a method of obtaining thermosetting polyimide resin by producing a solvent-soluble polyimide having a hydroxyl group, carboxyl group or aromatic halogen group according to the method of producing thermoplastic polyimide resin mentioned above, and then introducing a functional group such as an epoxy group, vinyl group, allyl group, methacryl group, acryl group, alkoxysilyl group, hydrosilyl group, carboxy group, hydroxy group or cyano group by a chemical reaction.

To the thermosetting resin may be further added a radical reaction initiator such as organic peroxides; a reaction promoting agent; an auxiliary cross-linking agent such as triallyl cyanurate or triallyl isocyanurate. When necessary, commonly used epoxy curing agents such as acid dianhydride-, amine- and imidazole-type agents and a variety of coupling agents may be added in order to improve heat resistance and adhesion property.

Further, in order to control the fluidity of the adhesive layer at the time of the thermal adhesion, a thermosetting resin may be added to the thermoplastic resin. For this purpose, 1 to 10,000 parts by weight, preferably 5 to 2,000 parts by weight of thermosetting resin are added based on 100 parts by weight of the thermoplastic resin. When the amount of thermosetting resin is too large, the adhesive layer may become brittle. On the other hand, when the amount is too small, the adhesive may protrude and the adhesion properties may decrease.

As the adhesive used in the laminate of the present invention, thermoplastic polyimide resin, thermosetting polyimide resin, epoxy resin, cyanate ester resin or a mixture thereof are preferable from the viewpoint of adhesion, processability, heat resistance, flexibility, dimensional stability, dielectric constant and cost. Mixtures of thermoplastic polyimide resin and epoxy resin, thermoplastic polyimide resin and cyanate ester resin, thermosetting polyimide resin containing a reactive group in the side chain and epoxy resin, and thermosetting polyimide resin containing a reactive group in the side chain and cyanate ester resin are preferable and of these, a mixture of thermoplastic polyimide resin and epoxy resin is suitable as it has good balance of adhesion, processability, and heat resistance.

The adhesive layer is formed by applying an adhesive made of thermoplastic resin or thermosetting resin to the polyimide film using for example a bar coater, spin coater or gravure coater.

The thickness of the adhesive layer is not particularly limited but is preferably 5 to 125 μm, more preferably 5 to 50 μm, most preferably 5 to 35 μm. The adhesive layer is required in such an amount, in other words thickness sufficient for burying the inner layer circuit pattern when laminating. Though depending on the pattern ratio of the inner layer circuit, usually, a thickness of approximately ½ to 1 time the thickness of the inner layer circuit is necessary for the adhesive layer. More specifically, in the case that the smallest practically effective circuit thickness is approximately 9 μm, and the pattern ratio is 50%, the thickness of the adhesive layer must be at least approximately 5 μm. When the adhesive layer is too thick, as in the case of the polymer film, the demand for thinning and miniaturization of printed wiring boards is countered and also problems are caused. For example, the adhesive protrudes from the substrate in the laminating step and contaminates the substrate products and processing facilities or volatile components such as a solvent may remain in the adhesive and cause foaming.

In order to prepare a laminate which has a structure of metal layer A/polymer film/adhesive layer, metal layer A is formed on one face of the polymer film by the method mentioned above and then adhesive layer 2 is formed, or the opposite sequence can be taken, as the effects of the present invention are not harmed. Examples of the method for forming the adhesive layer are the method of making the resin material to become the adhesive layer into a solution to apply and then dry and the method of melting and applying the resin material.

In addition to the aforesaid polymer film, metal layer A and adhesive layer, the laminate of the present invention may have when necessary a protective film on metal layer A. The protective film is described below.

<Protective Film>

The purpose of the protective film is to sustain the properties of the copper thin film made by the ion plating method until applied in the circuit forming process. When exposed to air for a long time, the adhesion of the ion plating coating to the electroless plating copper layer tends to decrease. The cause is most likely the progression of oxidation or the attachment of refuse to the surface of the copper. Furthermore, in preparing the multi-layer printed wiring board, heating is often conducted when applying the adhesive to the laminate and drying. Also, when laminating the laminate on the inner layer substrate, heating and pressurizing is common. In these cases, the metal layer is influenced by the heat and may be deteriorated by oxidation. On the other hand, after laminating the laminate circuit substrate to the inner layer substrate, in order to form a new circuit on the substrate surface, this protective film must be easy to peel off.

In a laminate to which an adhesive has been applied and dried, in some cases, the laminate may curl significantly due to the shrinkage of the adhesive. By attaching the protective film and increasing the overall rigidity of the laminate, the curling can be decreased.

The kind of material for the protective film is not particularly limited as long as the material has low adhesion to the metal layer. The method for forming the protective film is not particularly limited. For example, the metal layer may be subjected to organic coating forming treatment using an imizadole type compound or known rust proofing treatments such as chromate treatment or zincate treatment. This can provide long term storage stability.

The process for preparing the circuit substrate using the laminate of the present invention is described below.

<Process for Preparing Circuit Substrate>

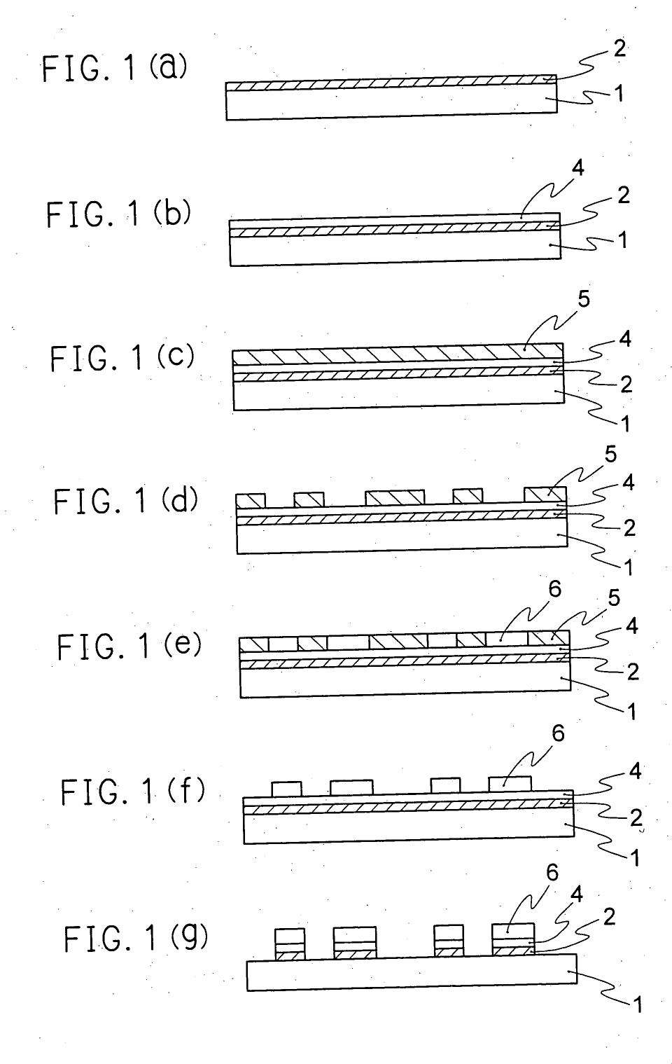

The process for preparing the circuit substrate using the laminate of the present invention is shown in FIG. 1.

First, metal layer A is formed on the surface of polymer film 1 by the dry plating method (FIG. 1(a)).

Next, a plating catalyst such as a palladium compound is applied to the surface of metal layer A, then electroless copper plating is conducted with the plating catalyst as the nucleus and electroless plating copper layer 4 is formed on the surface of the copper film (b).

Besides electroless copper plating, electroless nickel plating, electroless gold plating, electroless silver plating and electroless tin plating can be used in the present invention, but from an industrial viewpoint and the viewpoint of electric properties such as metal migration resistance, electroless copper plating and electroless nickel plating are preferable, particularly electroless copper plating.

As the electroless plating step, a known electroless plating treatment can be applied. Usually, the method goes through the steps of roughening the substrate surface, washing the substrate surface, predipping, applying the plating catalyst, activating the plating catalyst and forming the electroless plating coating. A plating coating of 200 to 300 nm is usually formed and depending on conditions, a plating coating of 800 to 1,000 nm is formed.

An electroless plating coating is to be formed on the inner face of a via and/or the inner face of a through hole formed by methods such as laser drilling and become a feeding electrode. Therefore, the thickness of the electroless plating layer is preferably 100 to 1,000 nm, more preferably 100 to 500 nm, most preferably 200 to 800 nm. When the electroless plating layer is thinner than 100 nm, the thickness of the electroplating varies when the electroless plating layer is used as the feeding electrode. When the thickness is greater than 1,000 nm, excess etching must be conducted in the etching step, the circuit thickness becomes thinner than the planned circuit value and the circuit width becomes narrow. Furthermore, problems may arise, such as undercut occurring and circuit shape deteriorating. When the processing time of electroless plating is too long, the adhesion strength to metal layer A tends to decrease and from this, the thickness of the electroless plating copper layer is preferably at most 800 nm.

Next, on the surface of the electroless plating copper layer formed in this way, resist coating 5 is applied (c) and the resist coating is removed from the part where the formation of the circuit is planned (d).

The resist coating used in the present invention is not particularly limited as long as it resists the plating solution for forming the second metal coating and when plating is conducted, the second metal coating has difficulty forming on the resist surface. An example is a resist coating formed by applying liquid resin by the screen-printing method to the part where formation of the circuit is not planned and then solidifying. Another example is formed by forming a photosensitive liquid resin or resin sheet on the surface of the first metal coating, then exposing the circuit shape, followed by removing the photosensitive resin of the part where formation of the circuit is planned. In order to correspond to the narrowing of pitches, a photosensitive plating resist having a resolution of at most 50 μm is preferably used. Naturally, a circuit having a pitch of at most 50 μm and a circuit having a pitch greater than this may exist in combination.

After the resist coating is formed, copper electroplating is conducted using the part where the electroless plating coating is exposed as the feeding electrode and on the surface of the electroless plating coating, electroplated copper layer 6 (second metal coating) is formed (e). Besides copper electroplating, known electroplating such as solder electroplating, tin electroplating, nickel electroplating and gold electroplating can be applied, but from an industrial viewpoint and the viewpoint of electric properties such as metal migration resistance, copper electroplating and nickel electroplating are preferable, particularly copper electroplating.

A known method is used for electroplating. Specifically, copper sulfate plating, copper cyanide plating and copper pyrophosphate plating are known but considering the handling of the plating solution, productivity and properties of the coating, copper sulfate plating is preferable. The composition of the plating solution and plating conditions for copper sulfate plating are presented below.

<Copper Sulfate Plating Conditions>

(Composition of Plating Solution)

Copper sulfate: 70 g/L

Sulfuric acid: 200 g/L

Chlorine ion: 50 mg/L

Additive: suitable amount

(Plating Conditions)

Temperature of solution: room temperature

Air stirring: done

Rocking cathode substrate: done

Cathode current density: 2 A/dm²

The thickness of the second metal coating formed here may be either thicker or thinner than the thickness of the resist coating. Also, the second metal coating may be formed by electroless plating instead of electroplating.

After copper electroplating, the resist coating is then removed (f). The resist peeling solution is accordingly decided depending on the resist coating used.

Next, the feeding layer composed of metal layer A and the electroless plating copper layer is removed by etching and the circuit is formed (g).

At this time, an etchant, which hardly erodes the second metal coating and selectively conducts etching of only the first metal coating, is used. That is, in the step for removing the electroless plating copper layer exposed by resist pattern removal and metal layer A by etching, when T1 represents the etching thickness for the electroplated copper layer per time necessary for removing the electroless plating copper layer and metal layer A and T2 represents the sum of the thickness of the electroless plating copper layer and metal layer A, an etchant in which T1/T2<1 is used. It is preferable that T1/T2 is as small as possible and T1/T2 is preferably 0.1 to 1, more preferably 0.1 to 0.5. As an etchant which fulfills these conditions, an etchant containing nitric acid and sulfuric acid as the main component is particularly useful and an etchant to which hydrogen peroxide or sodium chloride is further added is more useful. Here, the main component means the main component among the components other than water which compose the etchant.

More preferably, an etchant, whose etching rate based on the first metal coating is at least ten times the etching rate based on the second metal coating, is used. According to this, the second metal coating is not etched and the state when first formed is almost always maintained. Therefore, the rectangle circuit shape can almost always be maintained and a circuit with excellent shape can be obtained. As examples of the etchant, when nickel is used for the first metal coating and copper for the second metal coating, the etchant disclosed in JP-A-2001-140084 can be suitably used.

Here, the etching rate is calculated by the following equation from the weight decreased when a metal board of 40 mm×40 mm×0.3 mm (thickness) is left still being immersed in the etchant for three minutes.

Etching rate (μm/minute)=(weight decreased)×10000/(surface area×density of metal board×time immersed) (3)

Here, the density of the metal board is 8.845 g/cm³ for nickel, 8.92 g/cm³ for copper. The surface area is 4 cm×4 cm×2+4 cm×0.03 cm×4=32.48 cm² and the time immersed is 3 minutes.

A specific example of the etchant is an etchant (product name, Mec-Remover NH-1862) available from MEC CO. LTD., but any etchant having the aforesaid characteristics can be applied in the present invention. When the etching rate for the electroplated copper layer of this etchant is assumed to be 1, the etching rate of this etchant for various metals is 5 to 10 for the electroless plating copper layer, 5 to 10 for the sputtering copper layer and 10 to 20 for the sputtering nickel layer. For example, when the metal layer A is of a two layer structure of a nickel layer and a copper layer, the total thickness being 200 nm, and 200 nm of electroless copper plating is further conducted, the time necessary for completely removing 400 nm, which is the total thickness of metal layer A and the electroless plating copper layer, by etching is about 4 minutes and the thickness of the electroplated copper layer etched during this time was 80 nm. When a circuit pattern of a line/space of 10 μm/10 μm was prepared according to the aforesaid method for preparing a printed wiring board, the obtained circuit width was 9.8 μm after etching, compared to 10.0 μm before etching, and the shape was almost as planned. The etching rate was obtained by observing the change in etching thickness when each metal was immersed in the etchant.

When measuring the etching rate of a standard etchant for copper, the etching rate differs greatly depending on the method by which the copper layer is formed. A copper thin film formed by ion plating method can be etched with ease in the etching step of the semi-additive process.

Of the copper layers formed by the ion plating method, sputtering method, electroless plating method and electroplating method, the copper layer formed by ion plating method is highest in etching rate. A copper layer formed by sputtering method and an electroless plating copper layer come next in being easily etched. A copper layer formed by electroplating method is the most difficult to be etched. The etching rate of a copper layer formed by ion plating method is approximately three times that of a copper layer formed by sputtering method or electroless plating method. The etching rate of a copper layer formed by sputtering method or electroless plating method is approximately five to ten times that of a copper layer formed by electroplating method. That is, a copper layer formed by ion plating method has an etching rate of thirty to fifteen times that of a copper layer formed by electroplating method.

Therefore, the copper layer formed by ion plating method, sputtering method or electroless plating method and used as a feeding layer for electroplating can easily be removed by etching in the etching step of the semi-additive process.

Furthermore, in order to shorten the etching time to improve productivity, etching while conducting to the outside is effective and preferable.

Finally, finish processing such as electroless nickel plating or electroless gold plating is carried out according to need to prepare the printed wiring board.

When forming a high-density circuit of a line/space of at most 25 μm/25 μm, it is extremely important that the metal layer and the insulating substrate are firmly adherent. Particularly, not only in the semi-additive process but also in the step for preparing a double sided printed wiring board or multi-layer printed wiring board, electroless plating and electroplating are essential for the through hole or IVH (interstitial via hole) to have conductivity. However, these steps apply various chemical treatments of strong acid and strong alkali which may inflict considerable damage to the insulating resin and therefore, acquiring peeling strength of these circuit patterns is practically important.

In the process for preparing the circuit substrate mentioned above, for example the peeling strength of the metal layer formed by electroless plating or electroplating can be set to at least 5 N/cm. Conventionally, electroless plating copper is not known to demonstrate such strong peeling strength, particularly from polymer film having a Rz of at most 1 μm on the surface. The peeling strength of the metal layer is obtained by electroless plating to the metal layer, then without forming a resist pattern, carrying out electroplating for 40 minutes under a condition of 2 A/dm² over the whole area by copper sulfate plating, to form a copper plating layer of a thickness of 20 μm and then measuring the peeling strength of the metal layer from the polymer film according to JIS C6471 (peeling strength: B method) under the conditions of a measurement pattern width of 3 mm, a cross head speed of 50 mm/minute and a peeling angle of 180 degrees.

The process for preparing the multi-layer printed wiring board of the present invention is explained below.

<Process for Preparing Multi-Layer Printed Wiring Board>

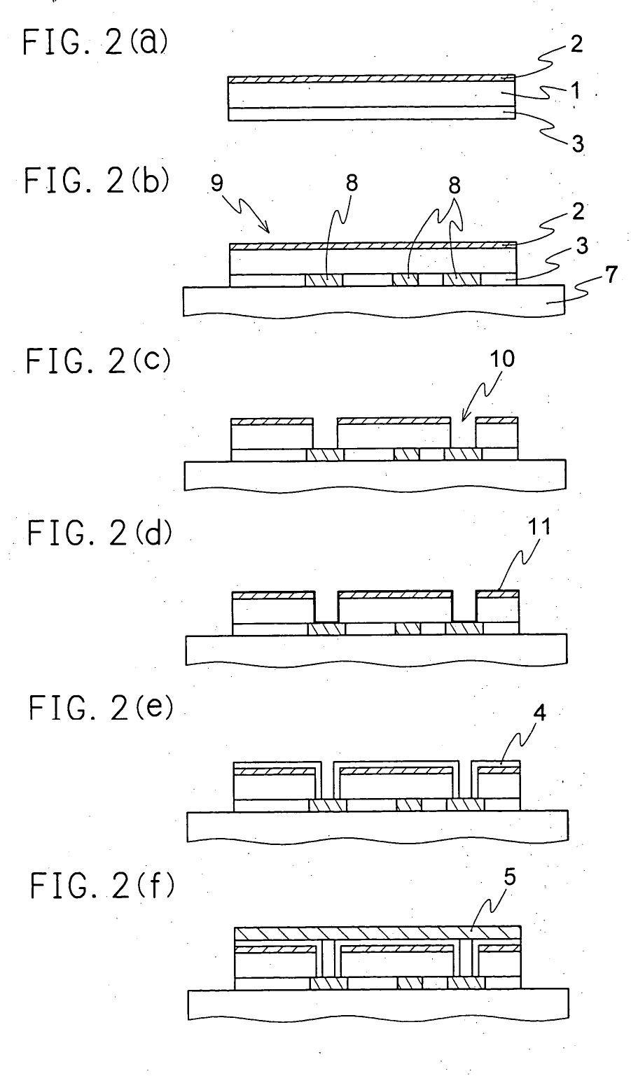

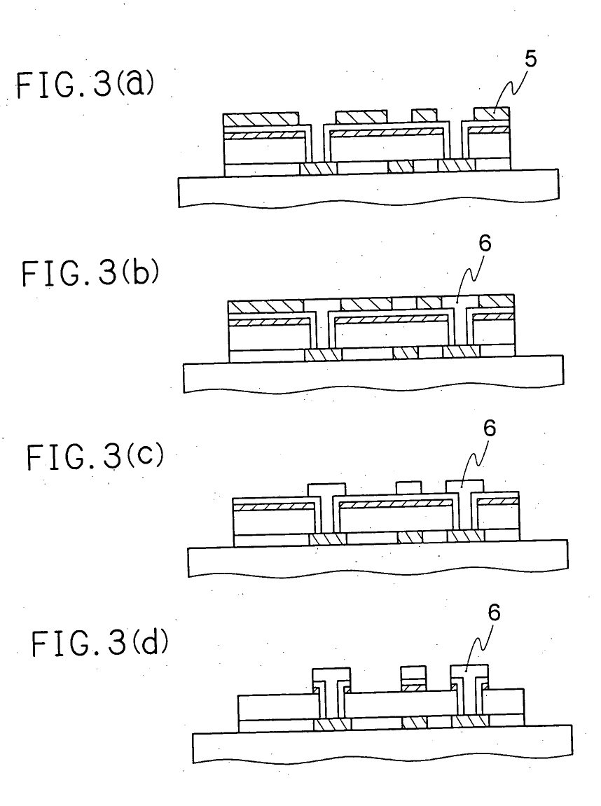

The process for preparing the build up multi-layer printed wiring board of the present invention is described in FIG. 2 and FIG. 3. Here, a laminate having adhesive layer 3 on one face of polymer film 1 is used. First, metal layer A is formed by dry plating on the surface of the polymer film (FIG. 2(a)).

The adhesive layer surface of the laminate is laminated to the circuit surface of printed wiring board 9 which has inner layer circuit 8 formed on insulating substrate 7, and the adhesive layer is thermally fused or hardened (FIG. 2(b)). The polymer film which composes the interlayer adhesive film becomes the resin insulating layer which composes the multi-layer printed board.

Lamination is conducted by a method which involves heating and/or pressurizing. Specifically, heating and pressurizing can be conducted by using a vacuum pressing machine equipped with a heater or a pressure welding device equipped with a heater and welding roll. For press processing, vacuum pressing and vacuum lamination can be applied besides oil press and an ordinary pressing machine. From the viewpoint of excluding the foam when laminating, burying the inner layer circuit and controlling the metal oxidation of metal layer A caused by heating, vacuum pressing and vacuum lamination is preferably used. Vacuum pressing is particularly preferred from the viewpoints of exclusion of foam when laminating and burying the inner layer circuit.

The temperature and pressure conditions when laminating can be set to the most suitable conditions depending on the composition of the interlayer adhesive film and the thickness of metal layer a of the inner layer circuit board. The laminating temperature is preferably at most 300° C., more preferably at most 250° C., further preferably at most 220° C., most preferably at most 200° C. In addition, the temperature is preferably at least 100° C., more preferably at least 160° C., most preferably at least 180° C. The laminating time is approximately 1 minute to 3 hours, more preferably 1 minute to 2 hours. The pressure is preferably 0.01 to 100 MPa. In the case of vacuum pressing and vacuum lamination, the pressure within the chamber is at most 10 kPa, more preferably at most 1 kPa.

After lamination, the laminated board can be placed in a curing oven such as a hot air oven and the thermosetting reaction of the adhesive layer can be advanced in the curing oven. Particularly when the laminating time is shortened, for example to at most 20 minutes, processing in the curing oven after lamination is preferable from the viewpoint of improving productivity.

Before conducting the laminating step, it is preferable that the surface of the inner layer circuit board is smoothed in advance, by applying adhesive layer varnish having the same composition as the adhesive layer to the inner layer circuit and then drying.

In the process for preparing the multi-layer printed wiring board of the present invention, polymer film is used. Therefore, when laminating to the inner layer wiring board, the inner layer circuit is buried into the adhesive layer and the burying of the inner layer circuit into the adhesive layer is finished in a state in which the inner layer circuit is adjacent to the polymer film. As a result, the thickness of the insulating interlayer is almost equal to the thickness of the polymer film and there is the effect of maintaining evenness of the thickness of the insulating layer. Furthermore, the polymer film of the present invention has the effect of improving interlayer insulation.

According to need, after conducting the laminating step and before conducting the plating layer formation step, through hole or via hole 10 is formed by drilling using a drill or laser on the designated position of the interlayer adhesive film (FIG. 2(c)). As the processing method, a known drilling machine, dry plasma device, carbon dioxide laser, UV laser or excimer laser may be used. For drilling of the via hole, laser drilling is effective for forming a blind via which is a small diameter via and UV-YAG laser is suited for drilling including the first metal coating.

According to need, cleaning the via hole by known methods such as desmear process is preferable. The desmear process is preferably conducted by the general wet process using permanganate or dry desmear using plasma. Particularly, dry desmear is preferable as it keeps down the damage to metal layer A of the laminate of the present invention and has the effect of removing smear on the bottom of the via. The desmear conditions can be adjusted according to the via drilling conditions. When a protective film is laminated on the metal layer, before conducting the above drilling, the protective film is peeled from the metal film.

Then as the next step, the metal layer a of the inner layer circuit board is conducted with the metal layer of the interlayer adhesive film through the through hole part or via hole part by electroless copper plating. More specifically, plating catalyst 11 such as a palladium compound is applied to the surface of the copper coating and the inside of the via hole (FIG. 2(d)), electroless copper plating is carried out with the plating catalyst as the nucleus and the electroless plating copper layer 4 is formed on the surface of the copper coating and the inside of the via hole (FIG. 2(e)).

Furthermore, resist coating 5 is applied or laminated to the surface of the electroless plating copper layer formed in this way (FIG. 2(f)). A film or liquid resist may be used according to need. The method of laminating film resist is preferable from the viewpoint of handling and evenness in thickness of the resist when later forming a circuit by plating.

The resist coating of the area where the formation of the circuit is planned is removed by photolithography (FIG. 3(a)). For forming a high-density circuit, the method of exposing and developing the resist of photosensitive material with a parallel light source is preferable. Also, the method of adhering the mask to the base material is preferable for attaining high resolution. On the other hand, when adhering the mask to the base, a scratch or stain on the mask may cause problems and the mask may be selected according to use.

Then, electroplating of copper is carried out using the exposed area of the electroless plating copper layer as the feeding electrode and on this surface and inside the via hole, electroplated copper layer 6 is formed (FIG. 3(b)). At this time, the via hole is filled with the electroplated copper coating. As the method for plating, the method of adjusting the plating solution additive and applying pulse currents may be employed. By combining these methods, a plating coating depending on use can be formed.

The resist coating is then removed (FIG. 3(c)). Usually, the resist coating is peeled by an alkaline solution.

The feeding layer composed of metal layer A and the electroless plating copper layer is removed by soft etching and the circuit is formed (FIG. 3(d)).

By going through the steps mentioned above, a multi-layer printed wiring board can be prepared, fully utilizing the characteristics of the laminate of the present invention. Particularly, an electroless plating catalyst must be applied for conduction of the via hole, but for areas other than the via hole, the catalyst is applied on the first metal coating and therefore the catalyst on unwanted areas can easily be removed by etching of the first metal coating.

In the above description, the method of preparing a multi-layer printed wiring board by laminating one sheet of interlayer adhesive film to the inner layer circuit board is given as an example. Also, for example, the multi-layer printed wiring board may be prepared by laminating two sheets of interlayer adhesive film, one to each face of the inner layer circuit board, or by further laminating another interlayer adhesive film above the interlayer adhesive film laminated to the inner layer circuit board. In other words, by repeating the above steps of FIG. 2(b) to FIG. 3(d), a multi-layer printed wiring board with a plurality of interlayer adhesive film laminated to one face or both faces of the inner layer circuit board can be prepared.

In the laminate of the present invention, the metal layer is formed on the polymer film which is a resin insulation layer, with the metal thin film formed directly by dry plating method, more specifically coating formation methods such as vacuum vapor deposition method, sputtering method and ion plating method, as the base. As a result, adhesion of the metal layer and the resin insulation layer is superior. In other words, the metal layer can be adhered to the polymer film and electric properties can be improved, without carrying out the step of roughening the surface of the polymer film. Therefore, because the step for preparing the interlayer adhesive film and the step for preparing the multi-layer printed wiring board can be simplified in comparison to the past, manufacturing cost can be reduced and the yield of the article can be improved.

Also, in both the aforementioned circuit substrate formation process and build up multi-layer substrate formation process, the etching process can be conducted efficiently.

Furthermore, in the process for preparing the printed wiring board using the laminate of the present invention, the metal layer A and the electroless plating layer are formed on polymer film with a smooth surface. As a result, etching can be conducted more rapidly than in prior arts in which the electroless plating layer is formed on roughened resin surface and this is industrially advantageous. Also, the fact that etching to deep within the roughened surface is unnecessary is considered to contribute to providing good circuit shape as planned.

Furthermore, there is extremely little etching remnant in the obtained circuit pattern and problems when forming the circuit such as ion migration disappear. In the semi-additive process of prior arts, the electroless plating copper coating and the plating catalyst for the electroless copper plating tends to remain on the surface of the insulation substrate and so the insulation property of the obtained printed wiring board tends to decrease. Furthermore, there was the problem that as nickel plating or gold plating is conducted in the last step, nickel or gold is plated to the surface of the insulation substrate due to the catalytic activity of the remaining plating catalyst and the circuit cannot be formed. However, in the present invention, catalyst for forming the electroless plating layer is applied to metal layer A which is formed by dry plating method and so the catalyst can be completely removed by etching treatment. Subsequently, according to the present invention, a high-density circuit excellent in adhesion to the substrate and insulation can be formed.

The process for preparing a circuit substrate using the laminate of the present invention is explained below based on Examples.

<Preparing Circuit Substrate>

### EXAMPLE 1

The first metal coating was formed by DC sputtering of nickel in a thickness of 300 nm on one face of a polyimide film having a thickness of 25 μm (Apical HP available from Kaneka Corporation).

Subsequently, a photosensitive dry film resist (Sunfort available from Asahi Kasei Corporation) was laminated by heating and exposed in the form of a circuit. The exposure was carried out to form a circuit of a comb-shaped electrode with a line width of 15 μm in an insulating interval of 15 μm.

Then the portion of the photosensitive resin where the formation of the circuit is planned was removed, leaving the resist coating on the part of the first metal coating surface excluding the portions where the formation of the circuit is planned, and copper electroplating was carried out to form the second metal coating having a thickness of 10 μm on the portions where the first metal coating is exposed.

Thereafter the resist coating was removed by using an alkaline peeling solution, and an etchant having a composition shown in Table 1 was sprayed on the substrate to carry out the etching of the first metal coating of nickel and a pattern of a line width of 15 μm with an insulating interval of 15 μm was formed. As a finishing step, electroless nickel plating was carried out to form a nickel metal coating having a thickness of 2 μm on the second metal coating, and electroless gold plating was carried out to form a gold metal coating having a thickness of 0.1 μm on the nickel coating to obtain a printed wiring board. The etching rate of the etchant used was 5.38 μm/minute for nickel and 0.04 μm/minute for copper.

TABLE 1
Composition of Etchant for Etching First Metal Coating

| | |
|---|---|
| Sulfuric acid (67.5%) | 50.0% by weight |
| Sulfuric acid (62.5%) | 10.0% by weight |
| Hydrogen peroxide (35%) | 1.0% by weight |
| Sodium chloride | 0.01% by weight |
| Deionization water | 38.99% by weight |

The circuit shape and insulating properties of the obtained printed wiring board were evaluated. Regarding the circuit shape, the portion of the circuit of the comb-shaped electrode exposed in a line width of 15 μm was observed by using a microscope and evaluated as “passed” when the rectangle shape remained and “not passed” when the apex of the rectangle is lost. As for the insulating properties, the insulation resistance was found between circuit lines which were not conducted with an insulation interval of 15 μm in the circuit of the comb-shaped electrode. The results are that the circuit shape was evaluated as “passed” and the insulation resistance was at least 1×10¹¹Ω. As stated above, Example 1 showed that a printed wiring board with excellent circuit shape and insulating properties could be easily prepared.

### EXAMPLE 2

A thin copper film was formed by ion plating on one face of a polyimide film having a thickness of 12.5 μm (Apical HP available from Kaneka Corporation). The surface smoothness of the polyimide film used in the experiment was 1 μm on a Rz value basis. The ionization condition was 40 V, and the bombardment condition was an argon gas pressure of 26 Pa and substrate heating temperature of 150° C. in principle. Films having a different thickness ranging from 5 to 100 nm were formed by this method.

Then a copper plating layer was formed on the laminate composed of polyimide film and ion plating copper layer by electroless plating method. The method for forming electroless plating layer is as follows: first, the laminate was cleaned by an alkaline cleaning solution and then a short time of pre-dipping was carried out with acid. Further, platinum was applied and reduction using alkali was conducted in an alkaline solution. Then chemical copper plating in alkali followed. The plating temperature was room temperature and the plating time was 10 minutes. The electroless plating copper layer having a thickness of 300 nm was formed by this method.

The adhesion strength of the thin copper film layers formed in this way was evaluated by the peeling strength value. In the evaluation of adhesion, the face peeled was always the interface between the polyimide film and the ion plating copper layer, and the conditions of ion plating did not affect the peeling strength so much although the thickness of the ion plating copper layer had an effect on the strength. That is, when the thickness of the ion plating layer was 20 nm or less, the adhesion strength ranged from 1 to 4 N/cm, varying widely from place to place. This seems to be because of the existence of the polyimide film partially exposed when the thickness is 20 nm or less. On the contrary, when the thickness of the ion plating layer is from 10 to 400 nm, the adhesion strength was stably 6 to 8 N/cm. When the thickness was 400 nm or more, the adhesion strength decreased to 6 to 4 N/cm.

An electroplating copper layer was formed on the thus-obtained laminate comprising the polyimide film (12.5 μm), ion plating copper layer (50 nm) and electroless plating copper layer (300 nm). Specifically, the laminate was subjected to pre-washing for 30 seconds in a 10% sulfuric acid and then plating for 40 minutes at room temperature. The current density was 2 A/dm² and the film thickness was 10 μm.

The peeling strength of the laminate was measured. The adhesion strength of the electroless plating layer and the electroplated layer, and the adhesion strength of the ion plating copper layer and the electroless plating layer were good. Although peeling occurred between the polyimide film and the ion plating copper layer, the strength was 6 to 7 N/cm, which proved that the formation of the electroplated copper layer did not have any bad influence on the adhesion property of each layer.

A resist solution (THB 320 P available from JSR Corporation) was spin-coated in a thickness of 10 μm on a laminate comprising a polyimide film (12.5 μm), ion plating copper layer (50 nm) and electroless plating copper layer (300 nm) prepared in the above manner. Then masking exposure was carried out by using a high-pressure mercury lamp, followed by peeling of the resist film to form a pattern of a line/space of 10 μm/10 μm.

Next, by using the copper layer comprising the ion plating copper layer (50 nm) and the electroless plating copper layer (300 nm) as a feeding layer, copper electroplating was carried out on the portions where the resist film was peeled. The thickness of the electroplated copper was 10 μm.

Thereafter the resist film was peeled by using an alkaline peeling solution and flash etching was carried out to remove the feeding layer. The flash etching was carried out by using a system of sulfuric acid/hydrogen peroxide/water. A pattern having a line width of 10 μm and a line interval of 10 μm was formed by this.

The cross section of the prepared circuit was observed by using an electron microscope. When the thickness of the ion plating copper layer was 400 nm or less, the feeding layer was completely removed with little under etching of the circuit by controlling the flash etching period appropriately. On the other hand, when the thickness of the ion plating copper layer was more than 400 nm, under etching of the circuit line was found to occur in an attempt to remove the feeding layer completely.

Then the insulating property of the prepared circuit pattern was measured. The measurement of the insulating property was carried out using a comb-shaped electrode having a space distance of 10 μm according to a known method (IPC-TM-650-2.5.17). The circuit showed an excellent insulation resistance of 10¹⁶ Ω/cm.

In addition, measurement according to the Auger analysis was conducted to observe whether any metal remained on the part from which the feeding layer was removed. There was no remnant metal.

### EXAMPLE 3

In the same manner as in Example 2, a thin copper film was formed on one face of a polyimide film by ion plating method.

Another thin copper film was formed on the thin copper film formed in that way by DC sputtering method. The conditions for sputtering were a DC power of 200 watt and an argon gas pressure of 0.35 Pa in principle. Films having a different thickness ranging from 5 to 1,000 nm were formed.

The adhesion strength of the thin copper film layers formed in this way was evaluated from the peeling strength value. In the evaluation of adhesion, the face peeled was always the interface of the polyimide film with the ion plating copper layer, and the conditions of ion plating did not affect the peeling strength so much although the thickness of the ion plating copper layer had an effect on the strength. That is, when the thickness of the ion plating layer is 10 nm or less, the adhesion strength ranged from 1 to 4 N/cm, varying widely from place to place. This seems to be because of the existence of the polyimide film partially exposed when the thickness is 10 nm or less. On the contrary, when the thickness of the ion plating layer is from 10 to 200 nm, the adhesion strength was stably 6 to 8 N/cm. When the thickness was 200 nm or more, the adhesion strength decreased to 6 to 4 N/cm.

In the same manner as in Example 2, an copper plating layer was formed by electroless plating method on the thus-obtained laminate comprising the polyimide film, ion plating copper layer and sputtered copper layer. The experiment was conducted by using samples which have a sputtered copper layer of different thickness with a fixed thickness of the ion plating copper layer of 50 nm. In the case of the sample without the sputtered copper layer, the ion plating copper layer peeled off of the polyimide substrate during the electroless plating. When the thickness of the sputtered copper layer is 10 nm or less, peeling occurred similarly.

When the thickness of the sputtered copper layer was 10 nm or more, the sputtered copper layer served as a protective film for the ion plating copper layer during the electroless plating, and peeling did not occur. In addition, the adhesion strength of the sputtered copper layer and the electroless plating copper layer was excellent, and the layers did not peeled off. In the peeling strength test, peeling occurred between the ion plating copper layer and the polyimide film, but an excellent peeling strength of at least 6 N/cm was exhibited. The thickness of the sputtered copper may be at least 10 nm and at most 200 nm. The peeling strength tended to decrease when the thickness was 200 nm or more.

In the same manner as in Example 2, an electroplating copper layer was formed on the laminate comprising the polyimide film (12.5 μm), ion plating copper layer (50 nm), sputtered copper layer (100 nm) and electroless plating copper layer (300 nm) prepared in the above manner.

The peeling strength of the laminate was measured. The adhesion strength between the electroless plating layer and electroplated layer was excellent, and peeling occurred between the polyimide film and the ion plating copper layer. However the strength was 6 to 7 N/cm, which proved that the formation of the electroplated copper layer did not have a bad influence on the adhesion property of each layer.

In the same manner as in Example 2, a resist pattern was formed on the laminate comprising the polyimide film (12.5 μm), ion plating copper layer (50 nm), sputtered copper layer (100 μm) and electroless plating copper layer (300 nm). Then copper electroplating was carried out on the portions where the resist was removed, and removal of the resist film and flash etching were carried out to form a pattern of a line width of 10 μm and a line interval of 10 μm.

The cross section of the prepared circuit was observed by using an electron microscope. When the thickness of the sputtered copper layer was 200 nm or less, the feeding layer was completely removed with little under etching of the circuit by controlling the flash etching period appropriately. On the other hand, when thickness of the sputtered copper layer was more than 200 nm, under etching of the circuit line was found to occur in an attempt to remove the feeding layer completely.

The measurement of insulating property of the prepared circuit pattern was carried out in the same manner as in Example 2. The circuit showed an excellent insulation resistance of 10¹⁶ Ω/cm.

In addition, measurement according to the Auger analysis was conducted to observe whether any metal remained on the part from which the feeding layer was removed. There was no remnant metal.

### EXAMPLE 4

A thin copper film was directly formed on one face of a polyimide film having a thickness of 12.5 μm (Apical HP available from Kaneka Corporation) by DC sputtering. The condition of the DC sputtering was the same as that of Example 3. Films of various thickness ranging from 5 to 1,000 nm were formed. When the adhesion strength was measured, the peeling strength was at most 1 N/cm in all film thickness.

### COMPARATIVE EXAMPLE 1

According to the curtain coating method, an epoxy resin was applied on the surface of an epoxy resin board clad with copper on both sides in which the copper foil was totally etched. The board was then heated at 150° C. for one hour to obtain an insulating substrate with a semi-hardened resin layer surface.

The insulating substrate was immersed in a potassium permanganate solution to make the surface of the resin layer rough in order to improve the adhesion with electroless plating. Thereafter a palladium-tin colloid plating catalyst was applied on the surface of the resin layer, and then electroless copper plating was carried out to form the first metal coating of copper having a thickness of 0.5 μm on the insulating substrate surface.

In the same manner as in Example 1, a resist coating was formed on the part excluding the portions where the formation of the circuit is planned, and the second metal coating of copper having a thickness of 10 μm was formed on the portions where the first metal coating is exposed.

Subsequently solder plating was carried out to form a solder metal coating (third metal coating) on the second metal coating.

The resist coating was removed by using an alkaline peeling solution and then the first metal coating was subjected to etching by spraying an alkaline etchant on the insulating substrate. The second metal coating was exposed by removing the third metal coating of solder formed on the second metal coating by using a solder peeling solution.

The insulating substrate was then immersed in a potassium permanganate solution to remove the semi-hardened resin layer on the insulating substrate surface, and after the plating catalyst remaining on the insulating substrate surface was removed, heating was carried out at 170° C. for two hours to harden the semi-hardened resin layer completely.

The circuit shape and insulating properties of the obtained printed wiring board were evaluated in the same manner as in Example 1. The results are that the circuit shape was evaluated as “passed” and the insulation resistance was at least 1×10⁹Ω. As described above, the insulating properties were found to be inferior in Comparative Example 1 as compared with Example 1. Further, since there is the need of forming a metal coating on the second metal coating and removing it, and the need of removing the plating catalyst, the steps are more complicated in Comparative Example 1 than in Example 1.

### COMPARATIVE EXAMPLE 2

A printed wiring board was prepared in the same manner as in Comparative Example 1 except that the resist coating and the first metal coating were removed without forming the solder metal coating (third metal coating) on the second metal coating.

The circuit shape and insulating properties of the obtained printed wiring board were evaluated in the same manner as in Example 1. The results are that the circuit shape was evaluated as “not passed” and the insulation resistance was at least 1×10⁹Ω. As described above, the circuit shape and insulating properties were found to be inferior in Comparative Example 2 compared with Example 1. Further, since there is the need of removing the plating catalyst, the steps are slightly complicated in Comparative Example 2 as compared with Example 1.

Next the process for preparing a build-up multi-layer printed wiring board using the laminate of the present invention is explained by means of Examples. In the following Examples and Comparative Examples, the adhesive solution prepared in the method as described below was used for the adhesive layer.

1 equivalent amount of bis{4-(3-aminophenoxy)phenyl}sulfon was dissolved in N,N-dimethylformamide in a 2,000 ml glass flask under nitrogen atmosphere. The solution was stirred while cooling with ice water, and 1 equivalent amount of 4,4′-(4,4′-isopropylidene diphenoxy)bisphthalic anhydride was dissolved in the solution to carry out polymerization. Consequently a polyamic acid polymer solution with a solid content concentration of 30% by weight was obtained. After heating the polyamic acid polymer solution at 200° C. (normal pressure) for three hours, the solution was further heated in vacuum of 665 Pa at 200° C. By this method, a solid thermoplastic polyimide resin was obtained.

The thermoplastic polyimide resin, a novolak epoxy resin Epicoat 1032H60 (available from Yuka Shell Epoxy K.K.) as a thermosetting resin and 4,4′-diaminodiphenyl sulfon as a curing agent were mixed in a weight ratio of 70/30/9. The mixture was dissolved in dioxolan (organic polar solvent) in a solid content concentration of 20% by weight, and the adhesive solvent was obtained.

<Preparing Build-Up Multi-Layer Printed Wiring Board>

### EXAMPLE 5

A thin copper film (metal layer) having a thickness of 300 nm was formed on one face of a polyimide film having a thickness of 12.5 μm (Apical NPI available from Kaneka Corporation) by the sputtering method using a DC magnetron sputter. The adhesive solution mentioned above was applied on the other face of the polyimide film by using a gravure coater so that the thickness after drying becomes 9 μm and by drying at 170° C. for 2 minutes, an adhesive layer was formed. An interlayer adhesive film was prepared in this manner.

An inner layer circuit board was prepared from a 9-μm-thick copper foil-clad glass epoxy board. After laminating the above interlayer adhesive film on the copper foil (metal layer a) of the inner layer circuit board, heating and pressing were carried out at 200° C. for two hours by using a vacuum press machine, so that the thermoplastic polyimide resin which is the adhesive layer was thermally fused with the copper foil.

Thereafter through holes were made in the interlayer adhesive film by using a laser, and a thin copper film having a thickness of 3 μm was electroless plating to the hole, thereby conducting the copper foil on the inner layer circuit board with the thin copper film of the interlayer adhesive film. Then, after forming a plating resist pattern by using a photosensitive dry film resist (product name: Sunfort AQ-2536, available from Asahi Kasei Corporation), a copper film (plating layer) having a thickness of 20 μm was formed by copper electroplating on the portions of the thin copper film where a circuit pattern is to be formed. Thereafter the plating resist was peeled and the copper thin film was removed by soft etching. And a multi-layer printed wiring board having a fine circuit pattern of a line/space of 30 μm/30 μm was thus obtained.

### EXAMPLE 6

A multi-layer printed wiring board was prepared in the same manner as in Example 5 except that a thin copper film (metal layer) was formed on one face of a polyimide film in a thickness of 300 nm by ion plating method instead of sputtering method. A fine circuit pattern having a line/space of 30 μm/30 μm was formed on the multi-layer printed wiring board.

### EXAMPLE 7

A multi-layer printed wiring board was prepared in the same manner as in Example 5 except that a thin copper film (metal layer) was formed on one face of a polyimide film in a thickness of 300 nm by vacuum vapor deposition method instead of sputtering method. A fine circuit pattern having a line/space of 30 μm/30 μm was formed on the multi-layer printed wiring board.

### EXAMPLE 8

A multi-layer printed wiring board was prepared in the same manner as in Example 5 except that a two-layer structure metal layer was formed by forming a thin nickel film on one face of a polyimide film in a thickness of 30 nm by sputtering method and then forming a thin copper film on the thin nickel film in a thickness of 300 nm. A fine circuit pattern having a line/space of 30 μm/30 μm was formed on the multi-layer printed wiring board.

### EXAMPLE 9

A first metal coating was formed on one face of a polyimide film of a laminate in the same manner as in Example 1, and the adhesive solution was applied to the other face of the polyimide film so that the thickness of the adhesive becomes 9 μm after drying. Then drying was carried out at 170° C. for 2 minutes to form the adhesion layer and the laminate for the build-up multi-layer printed wiring board was prepared. An inner layer circuit board was prepared from a 9-μm-thick copper foil-clad glass epoxy laminated board and the laminate for the build-up multi-layer printed wiring board was laminated on the surface of the inner layer circuit board by using a vacuum press under the conditions of 200° C. for 2 hours to cure.

Via holes were made by using a UV-YAG laser and after electroless plating catalyst was applied all over the substrate, a resist coating was formed in the same manner as in Example 1 on the part excluding the portions where circuits and via holes are to be formed. Subsequently holes made by using the laser were conducted by electroless plating and further, copper electroplating was carried out to form the second metal coating of copper having a thickness of 10 μm on the exposed first metal coating surface. Then the plating resist was peeled off and the first metal coating was etched in the same manner as in Example 1 to prepare a multi-layer printed wiring board having a fine circuit of a circuit width of 15 μm and an insulation interval of 15 μm.

The circuit shape and insulating property of the obtained printed wiring board was evaluated in the same manner as in Example 1. Results similar to those of Example 1 were obtained.

### EXAMPLE 10

The adhesive solution was applied to one face of a polyimide film having a thickness of 12.5 μm (Apical NPI available from Kaneka Corporation) so that the thickness after drying becomes 9 μm. Then drying was carried out at 170° C. for 2 minutes to form the adhesion layer.

An ion plated copper layer (50 nm) was then formed on the other face of the polyimide film in the same manner as in Example 2 and the laminate for the build-up multi-layer printed wiring board was prepared.

An inner layer circuit board was prepared from a 9-μm-thick copper foil-clad glass epoxy laminated board and the laminate for the build-up multi-layer printed wiring board was laminated on the surface of the glass epoxy laminated board by using a vacuum press under the conditions of 200° C. for 2 hours to cure.

Next, a circuit pattern was formed on the surface of the ion plating copper layer using a photo resist in the same manner as in Example 2. Via holes were made by UV-YAG laser and after a catalyst was applied all over the substrate and inside the via hole, electroless plating was carried out. Conduction of the laser hole was attained by electroless copper plating and electroplating was carried out to form a copper plated layer of a 10 μm thickness. The plated resist was peeled and the feeding layer was etched in the same manner as in Example 2, and a build-up multi-layer printed wiring board with a microcircuit of a line width of 10 μm and insulation interval of 10 μm was obtained.

The circuit shape and insulation properties of the obtained printed wiring board were evaluated. Regarding the circuit shape, the portion of the circuit of the comb-shaped electrode exposed in a line width of 10 μm was observed by using a microscope and evaluated as “passed” when the rectangle shape remained and “not passed” when the apex of the rectangle is lost. As for the insulating properties, the insulation resistance was found between circuits which were not conducted with an insulation interval of 10 μm in the circuit of the comb-shaped electrode. As a result, it was found that a printed wiring board with excellent circuit shape and insulating properties could be easily prepared in Example 10 as compared with Comparative Example 2.

### EXAMPLE 11

The adhesive solution was applied to one face of a polyimide film having a thickness of 12.5 μm (Apical available from Kaneka Corporation) so that the thickness after drying becomes 9 μm. Then drying was carried out at 170° C. for 2 minutes to form the adhesion layer.

An ion plating copper layer (20 nm) and sputtering copper layer (100 nm) were then formed on the other face of the polyimide film in the same manner as in Example 3 and the laminate for the build-up multi-layer printed wiring board was prepared.

An inner layer circuit board was prepared from a 9-μm-thick copper foil-clad glass epoxy laminated board and the laminate for the build-up multi-layer printed wiring board was laminated on the surface of the glass epoxy laminated board by using a vacuum press under the conditions of 200° C. for 2 hours to cure.

Next, a circuit pattern was formed on the surface of the sputtering copper layer using a photo resist in the same manner as in Example 3. Via hole were made by using UV-YAG laser and after a catalyst was applied all over the substrate and inside the via hole, electroless plating was carried out. The inside of the via hole was conducted by electroless copper plating and copper electroplating was carried out to form a copper plated layer of a 10 μm thickness and in addition to fill the inside of the via hole with copper. The plated resist was peeled and the feeding layer was etched in the same manner as in Example 3 to obtain a build-up multi-layer printed wiring board with a microcircuit of a line width of 10 μm and insulation interval of 10 μm.

The circuit shape and insulation properties of the obtained printed wiring board were evaluated in the same manner as Example 10. As a result, it was found that a printed wiring board with excellent circuit shape and insulating properties could be easily prepared in Example 11 as compared with Comparative Example 2.

### EXAMPLE 12

A polyimide film was synthesized according to the following method.

1 equivalent amount each of para-phenylenediamine (PDA) and 4,4′-diaminodiphenylether (ODA) were dissolved into N,N-dimethylformamide (DMF) inside a separable flask. Then, 1 equivalent amount of p-phenylenebis(trimellitic acid monoester anhydride) (TMHQ) was added and the mixture was stirred for 30 minutes. 0.9 equivalent amount of pyromellitic acid dianhydride (PMDA) was further added and the mixture was stirred for 30 minutes. Next, while being careful of increase in viscosity, a DMF solution of PMDA (concentration 7%) was added and the viscosity at 23° C. was adjusted to be 2,000 to 3,000 poise to obtain the DMF solution of the polyamic acid polymer. The amount of DMF to be used was set so that the concentration of charged monomers, the diamine component and the tetracarboxylic acid dianhydride component, would be 18% by weight. Also, polymerization was conducted at 40° C.

10 g of acetic anhydride and 10 g of isoquinoline based on 100 g of the above polyamic acid solution were added and after stirring until homogeneous, defoaming was carried out. The solution was then applied to the glass board by casting. After drying at about 110° C. for 5 minutes, the polyamic acid coating was peeled form the glass board and a gel film having self supporting properties was obtained. This gel film was immersed for 1 minute in a 1-butanol solution of TBSTA adjusted to a titanium concentration of 100 ppm and droplets were removed from the surface of the film. The film was then secured in a frame, heated for about 1 minute at 200° C., 1 minute at 300° C., 1 minute at 400° C. and 1 minute at 500° C. and subjected to dehydration ring closing drying to obtain a polyimide film of about 25 μm in thickness. This polyimide film had a tensile elastic modulus of 6 GPa, tensile elongation of 50%, water absorption of 1.2%, dielectric constant of 3.4, dielectric loss tangent of 0.01 and 10 point average roughness Rz of 0.2 μm.

Thereafter, by the following method, using a sputtering device NSP-6 made by SHOWA SHINKU CO. LTD, a metal layer was formed on the polyimide film prepared by the above method.

The polymer film was set in a jig and the vacuum chamber was closed. The chamber was evacuated to at most 6×10⁻⁴ Pa while the substrate (polymer film) was subjected to rotation and revolution and heated by a lamp heater. Argon gas was introduced to set the pressure to 0.35 Pa and nickel of 20 nm in thickness and then copper of 10 nm in thickness were sputtered by DC sputtering. Both were sputtered at a DC power of 200 watts. The film forming speed was 7 nm/minute for nickel, 11 nm/minute for copper and the thickness of the film was controlled by adjusting the film forming time.

The adhesive solution was applied using a comma coater so that the thickness after drying becomes 9 μm, to the face of the polyimide film opposite to the face on which the metal layer was formed. The adhesive layer was formed by drying at 170° C. for 2 minutes and the laminate for the build up multi-layer printed wiring board was prepared.

Using the obtained interlayer adhesive film, a multi-layer printed wiring board was prepared according to the following method.

The interlayer adhesive film was laminated by pressing to an inner layer circuit (FR4 substrate of a 9 nm thickness) under conditions of a temperature of 200° C., a pressure of 3 MPa and a vacuum degree of 10 Pa. Via holes of 30 μm in diameter are made by using an UV-YAG laser in necessary positions. Plating was then carried out according to the electroless copper plating process by Atotech Co., Ltd. under the conditions of 5 minutes of cleaner conditioner (product name: Cleaner Securiganth 902), 1 minute of pre-dipping (product name: Predip Neoganth B), 5 minutes of activator (product name: Acukivator Neoganth 834 Conc.), 2 minutes of reduction (product name: Reducer Neoganth) and 15 minutes of electroless copper plating (Printoganth MSK-DK).

After washing the electroless plating copper layer with acetone, liquid photo resist available from JSR Corporation (product name: THB-320P) was spin-coated at 1000 RPM for 10 seconds and after drying for 10 minutes at 110° C., a resist layer of 10 μm in thickness was formed. Then, a glass mask having a line/space of 10/10 μm was adhered to the resist layer and exposed for 1 minute with an ultraviolet exposing device of a ultra-high pressure mercury lamp. By immersing in a developing solution available from JSR Corporation (product name: PD523AD) for 3 minutes, the photosensitized area was removed and a pattern having a line/space of 10/10 μm was formed.

The obtained laminate substrate was subjected to electroplating by a copper sulfate plating solution at a current density of 2 A/dm² for 20 minutes and a pattern of a 10 μm thickness was formed on the area where the resist was removed. The obtained circuit substrate was washed with acetone to peel off the resist layer which remained on the substrate and then immersed in an etchant available from MEC CO., LTD. (product name: Mec-Remover NH-1862) for 5 minutes. The etching rate of this etchant is faster for nickel compared to copper and so when removing nickel on areas other than the circuit, the damage to the copper of the circuit area can be kept to a minimum.

The circuit of the obtained multi-layer printed wiring board was observed with a scanning electron microscope and was confirmed to have formed a circuit in which line/space=10/10 μm as planned. Also, the space area was smooth and etching remnant of neither nickel or copper was found. Furthermore, the cross section shape of the copper conduction circuit which should be rectangular maintained a rectangular shape as planned, as narrowing of the circuit did not occur in the etching step.

The peeling strength of the metal layer from the polymer film when the thickness of the metal layer was 20 μm was 6.8 N/cm, which was sufficient for forming high-density wiring.

### EXAMPLE 13

A printed wiring board was prepared and evaluated in the same manner as in Example 12 except that the thickness of the sputtered nickel layer was 10 nm and the thickness of the sputtered copper layer was 50 nm. As a result, a circuit having a line/space of 10/10 μm was confirmed to have been favorably prepared. In addition, the peeling strength of the metal layer from the polymer film was 8.2 N/cm, which was sufficient for forming high-density wiring.

### EXAMPLE 14

A printed wiring board was prepared and evaluated in the same manner as in Example 12 except that the thickness of the sputtered nickel layer was 10 nm and the thickness of the sputtered copper layer was 100 nm. As a result, a circuit having a line/space of 10/10 μm was confirmed to have been favorably prepared. In addition, the peeling strength of the metal layer from the polymer film was 9.6 N/cm, which was sufficient for forming high-density wiring.

### EXAMPLE 15

A printed wiring board was prepared and evaluated in the same manner as in Example 12 except that a 10-nm thick nickel/chrome alloy sputtered layer was formed and the thickness of the sputtered copper layer was 100 nm. As a result, a circuit having a line/space of 10/10 μm was confirmed to have been favorably prepared. In addition, the peeling strength of the metal layer from the polymer film was 10.6 N/cm, which was sufficient for forming high-density wiring.

### EXAMPLE 16

A printed wiring board was prepared and evaluated in the same manner as in Example 12 except that the thickness of the sputtered nickel layer was 10 nm and the thickness of the sputtered copper layer was 200 nm. As a result of visual observation of the circuit, etching of the space area was insufficient. In order to etch the space area sufficiently, 30 minutes of etching was necessary. The circuit of the obtained printed wiring board was decreased in width due to etching and particularly, the upper area of the circuit had been rounded and narrowed.

### EXAMPLE 17

A coating of 20 nm of nickel and then 10 nm of copper was formed on one face of a polyimide film having a thickness of 12.5 μm (Apical HP available from Kaneka Corporation) by the sputtering method using a DC magnetron sputter to obtain a laminate. The adhesive solution was applied to the polyimide film side of the above laminate so that the thickness after drying becomes 9 μm and the adhesive layer was formed by drying at 170° C. for 2 minutes to obtain the interlayer adhesive film.

An inner layer circuit board was prepared from a 9-μm-thick copper foil-clad glass epoxy laminated board. The above interlayer adhesive film was laminated by a vacuum press on the inner layer circuit board and cured under conditions of a temperature of 200° C., a hot plate pressure of 3 MPa, a pressing time of 2 hours and a vacuum condition of 1 KPa.

Via holes of 30 μm in diameter which run to the electrodes were opened directly above electrodes on the inner layer board by an UV-YAG laser. Subsequently, electroless copper plating was conducted to all over the substrate. The method for forming the electroless plating layer is the same as that of Example 2. A liquid photosensitive plating resist (available from JSR Corporation, product name: THB320P) was coated and a resist layer of 10 μm in thickness was formed by drying for 10 minutes at 110° C. A glass mask having a line/space of 10/10 μm was adhered to the resist layer and exposed for 1 minute with an ultraviolet exposing device of a ultra-high pressure mercury lamp. Then, by immersing in a developing solution (available from JSR Corporation, product name: PD523AD) to remove the photosensitized area and a plating resist pattern having a line/space of 10/10 μm was formed.

Next, a copper pattern of a 10 μm thickness was formed on the area where the electroless plating copper layer was exposed by a using a copper sulfate plating solution. As for the copper electroplating, pre-rinsing was carried out for 30 seconds in 10% sulfuric acid and then plating was carried out for 20 minutes at room temperature. The current density was 2 A/dm² and the film thickness was 10 μm.

The plating resist was peeled off using acetone. Furthermore, by immersing in a etchant available from MEC CO., LTD. (product name: Mec-Remover NH-1862) for 5 minutes and then removing the portions other than the circuit area of the electroless plating copper layer, copper thin film and nickel thin film, a printed wiring board was obtained.

The obtained printed wiring board had a line/space almost exactly as the planned value and had no side etch. In addition, measurement according to the Auger analysis was conducted to observe whether any metal remained on the part from which the feeding layer was removed and there was no remnant metal. Also, the adhesion of the circuit was firm.

Furthermore, in the etching step of this Example, etching was carried out while conducting to the outside. In this case, by the measurement according to the Auger analysis to observe whether any metal remained on the part from which the feeding layer was removed, remnant metal was found to disappear by immersing in the etchant for approximately 2 minutes.

### EXAMPLE 18

A printed wiring board was obtained in the same manner as in Example 17 except that a coating of 10 nm of nickel and then 50 nm of copper was formed by the sputtering method using a DC magnetron sputter. The obtained printed wiring board had a line/space almost exactly as the planned value and had no side etch. In addition, measurement according to the Auger analysis was conducted to observe whether any metal remained on the part from which the feeding layer was removed and there was no remnant metal. Also, the adhesion of the circuit was firm.

### EXAMPLE 19

A printed wiring board was obtained in the same manner as in Example 17 except that a coating of 10 nm of nickel and then 100 nm of copper was formed by the sputtering method using a DC magnetron sputter. The obtained printed wiring board had a line/space almost exactly as the planned value and had no side etch. In addition, measurement according to the Auger analysis was conducted to observe whether any metal remained on the part from which the feeding layer was removed and there was no remnant metal. Also, the adhesion of the circuit was firm.

### EXAMPLE 20

A printed wiring board was obtained by the same manner as in Example 17 except that a coating of 10 nm of nickel chrome alloy and then 10 nm of copper was formed by the sputtering method using a DC magnetron sputter. The obtained printed wiring board had a line/space almost exactly as the planned value and had no side etch. In addition, measurement according to the Auger analysis was conducted to observe whether any metal remained on the part from which the feeding layer was removed and there was no remnant metal. Also, the adhesion of the circuit was firm.

### EXAMPLE 21

A printed wiring board was obtained by the same manner as in Example 17 except that a coating of 10 nm of nickel chrome alloy and then 50 nm of copper was formed by the sputtering method using a DC magnetron sputter. The obtained printed wiring board had a line/space almost exactly as the planned value and had no side etch. In addition, measurement according to the Auger analysis was conducted to observe whether any metal remained on the part from which the feeding layer was removed and there was no remnant metal. Also, the adhesion of the circuit was firm.

### COMPARATIVE EXAMPLE 3

Electrolytic copper foil having a thickness of 18 μm was laminated on one face of a polyimide film having a thickness of 12.5 μm (Apical NPI available from Kaneka Corporation) through an epoxy type adhesive. An adhesive solution of thermoplastic polyimide resin was applied on the other face of the polyimide film by using a gravure coater so that the thickness after drying becomes 9 μm. The adhesive layer was formed by drying and the interlayer adhesive film was prepared from this.

An inner layer circuit board was prepared from a 9-μm-thick copper foil-clad glass epoxy laminated board. After laminating the above interlayer adhesive film on the copper foil of the inner layer circuit board, heating and pressing were carried out at 200° C. for two hours by using a vacuum pressing machine, so that the thermoplastic polyimide resin which is the adhesive layer is thermally fused with the copper foil.

After drilling was carried out to the interlayer adhesive film by using a laser, the thickness of the electrolytic copper foil was set to 33 μm by electroless copper plating and copper electroplating and the copper foil on the inner layer circuit board was conducted to the electrolytic copper foil of the interlayer adhesive film. Then, after forming a plating resist pattern by using a photosensitive dry film resist (product name: Sunfort AQ-2536, available from Asahi Kasei Corporation) on the electrolytic copper foil of the interlayer adhesive film, a copper film (plated layer) having a thickness of 20 μm was formed by copper electroplating on the portion of the electrolytic copper foil where a circuit pattern is to be formed. Thereafter, the plating resist was peeled and the electrolytic copper foil was removed by soft etching. However, due to the influence of side etching, the width (line) of the circuit pattern became uneven and short circuiting and breaking occurred in many places. Therefore, a multi-layer printed wiring board on which a microcircuit having a line/space of 30 μm/30 μm is formed could not be obtained.

### COMPARATIVE EXAMPLE 4

A multi-layer printed wiring board was formed in the same manner as in Example 5 except that a copper thin film of a 2 μm thickness was formed on one face of the polyimide film by electroless copper plating rather than sputtering method. However, because adhesion of the copper thin film to the polyimide film is weak, the copper thin film peels from the polyimide film and a circuit could not be formed.

### COMPARATIVE EXAMPLE 5

Interlayer insulating material made from epoxy resin (ABF-SH-9K available from Ajinomoto-Fine-Techno Co., Inc.) was laminated to a FR4 substrate having a circuit thickness of 9 μm at a temperature of 90° C. and then cured for 30 minutes at 170° C.

After conducting surface roughening of the obtained laminate by permanganate method according to desmear process, the steps of Example 12 from the electroless plating process onward were conducted and a multi-layer printed wiring board was prepared and evaluated.

After roughening the surface of the resin, the 10 point average roughness was 3.0 μm. In the obtained multi-layer printed wiring board, the circuit width was not stable because unevenness of the resin surface was great. Furthermore, when the space area was observed with a SEM, nickel etching remnant was found in the uneven parts. The adhesion strength of the resin layer and the metal layer was 7.4 N/cm.

### INDUSTRIAL APPLICABILITY

According to the present invention, by forming metal layer A on the polymer film by dry plating method, a wire circuit which adheres firmly even to polymer film with excellent surface smoothness can be formed on. Also, because adhesion is excellent, electric properties can be improved. Furthermore, the thickness of the polymer film which is the insulating layer can be made thin and even. Therefore, when preparing a printed wiring board using this laminate, a wire circuit excellent in adhesion strength and shape can be prepared and a printed wiring board with excellent insulation resistance can be obtained. Particularly, the laminate is suitable for forming a high-density circuit having a line/space of at most 25 μm.

According to the present invention, because the other face of the polymer film of the above laminate has an adhesive layer, an interlayer adhesive film for a multi-layer printed wiring board which is suitable for forming a fine pattern can be provided. When a multi-layer printed wiring board is prepared using the laminate, the preparation process can be simplified in comparison to prior arts and so production cost can be reduced and the yield of the product can be improved. As a result, a multi-layer printed wiring board with a fine pattern, particularly a circuit pattern formed by the semi-additive method can be prepared easily and at a low price.

Furthermore, according to the present invention, a printed wiring board with excellent circuit shape in the second metal layer can be obtained when removing the first metal coating, by using an etchant which selectively etches the first metal coating.

1. A laminate comprising a metal layer A having a thickness of at most 1,000 nm, which is laminated at least on one face of a polymer film.

2. A laminate comprising a metal layer A having a thickness of at most 1,000 nm on one face of a polymer film and an adhesive layer on the other face of the polymer film.

3. The laminate of claim 1 or 2, wherein said metal layer A is formed by dry plating method.

4. The laminate of claim 1 or 2, wherein said metal layer A is copper or a copper alloy formed by ion-plating method.

5. The laminate of claim 1 or 2, wherein said metal layer A comprises a metal layer A1 which contacts with said polymer film and a metal layer A2 formed on said metal layer A1.

6. The laminate of claim 5, wherein said metal layer A1 has a thickness of 2 to 200 nm.

7. The laminate of claim 5, wherein said metal layer A2 has a thickness of 10 to 300 nm.

8. The laminate of claim 5, wherein said metal layer A1 and said metal layer A2 comprise copper or a copper alloy formed by two different kinds of physical methods.

9. The laminate of claim 8, wherein said metal layer A1 is copper or a copper alloy formed by ion-plating method.

10. The laminate of claim 8, wherein said metal layer A2 is copper or a copper alloy formed by sputtering method.

11. The laminate of claim 5, wherein said metal layer A1 comprises one kind of metal and said metal layer A2 comprises another kind of metal.

12. The laminate of claim 11, wherein said metal layer A1 comprises nickel or an alloy thereof and said metal layer A2 comprises copper or an alloy thereof.

13. The laminate of claim 11, wherein said metal layer A1 and said metal layer A2 are formed by sputtering method.

14. The laminate of claim 11, which has no oxide layer between said metal layer A1 and said metal layer A2.

15. The laminate of claim 1 or 2, wherein the surface of said polymer film has a ten point average roughness of at most 3 μm.

16. The laminate of claim 1 or 2, wherein the surface of said polymer film has a dielectric constant of at most 3.5 and a dielectric loss tangent of at most 0.02.

17. The laminate of claim 2, wherein said polymer film contains a non-thermoplastic polyimide resin component.

18. The laminate of claim 2, wherein said adhesive layer comprises an adhesive containing thermoplastic polyimide resin.

19. The laminate of claim 2, wherein said adhesive layer comprises a polyimide resin and a thermosetting resin.

20. The laminate of claim 1 or 2, which has a protective film on said metal layer A.

21. The laminate of claim 1 or 2, wherein said metal layer A has a peeling strength of at least 5 N/cm.

22. A process for preparing a printed wiring board, which comprises forming, on a polymer film, a printed wiring board having a pattern by a first metal coating and a second metal coating, by semi-additive method, wherein an etchant such that the etching rate for the first metal coating is at least 10 times the etching rate for the second metal coating is used.

23. The process of claim 22, wherein said first metal coating is at least one metal selected from the group consisting nickel, chromium, titanium, aluminum, tin and alloys thereof, and said second metal coating is selected from the group consisting of copper and alloys thereof.

24. A process for preparing a printed wiring board, which comprises forming a circuit by using the laminate of claim 1 or 2.

25. A process for preparing a printed wiring board, which comprises forming a through hole in the laminate of claim 1 and then conducting electroless plating.

26. A process for preparing a printed wiring board, which comprises laminating a conductive foil on the adhesive layer of the laminate of claim 2, forming a through hole, and conducting electroless plating.

27. A process for preparing a multi-layer printed wiring board, which comprises facing the adhesive layer of the laminate of claim 2 with the circuit face of an inner layer circuit board on which a circuit pattern is formed, and then conducting heating and/or pressing, thereby laminating the laminate and the inner layer circuit board.

28. The process of claim 27, further comprising the steps of: making a through hole leading to an electrode on the inner layer circuit board from the surface of the metal layer of the laminate; and panel-plating by electroless plating.

29. The process of claim 25, 26 or 28, further comprising a desmear process step after making a through hole.

30. The process of claim 29, wherein the desmear process is dry desmear.

31. The process of claim 28, further comprising the steps of:
forming a resist pattern using photosensitive plating resist;
forming a circuit pattern by electroplating;
removing said resist pattern; and
removing said electroless plating layer exposed by removing of said resist pattern and said metal layer A by etching.

32. The process of claim 31, wherein the resist pattern forming step is conducted by using a dry film resist.

33. The process of claim 27, wherein said laminate and said inner layer circuit board are laminated by using vacuum pressing machine at most 10 kPa.

34. The process of claim 28, wherein the through hole making step is carried out by using a laser drilling system.

35. The process of claim 31, wherein an etchant in which etching thickness for electroplated layer per time required to remove said electroless plating layer exposed by resist pattern removal and said metal layer A is smaller than the total thickness of said electroless plating layer and said metal layer A is used.
